(19) United States
(12) Patent Application Publication
(10) Pub. No.: US 2026/0219134 A1
(43) Pub. Date: Jul. 30, 2026

(54) DETECTION OF ANOMALIES IN COMPONENTS

(71) Applicant: Honeywell International Inc., Charlotte, NC (US)

(72) Inventors: Kantha Chikkegowda, Bangalore (IN); Shinoy M S, Bangalore (IN); Jaykishan Prajapati, Morena (IN)

(21) Appl. No.: 19/089,061

(22) Filed: Mar. 25, 2025

(30) Foreign Application Priority Data
Jan. 30, 2025 (IN) 202511007931

(51) Int. Cl. G01M 15/05; G07C 5/08

(52) U.S. Cl. CPC G01M 15/05; G07C 5/0808; G07C 5/0816

(57) ABSTRACT

Techniques for detection of anomalies in components are disclosed. One or more detection parameters corresponding to a component of an aerial vehicle are obtained from a plurality of sensors. A set of detection features corresponding to the one or more detection parameters are extracted. An anomaly signature corresponding to the extracted set of detection features is ascertained. The anomaly in operation of the component, the type of the anomaly, and the cause of the anomaly are identified. The analysis model is trained to identify the anomaly, the type of anomaly, and the cause of the anomaly based on a baseline anomaly signature. In response to the detection of the anomaly, an alert is triggered, and one or more recommendations are provided.

### BACKGROUND

Generally, vehicles use various components for operation thereof. For instance, vehicles, such as aerial vehicles, include engines, wings, landing gears, flight control systems, and the like, for the operation. The performance of the vehicle depends on the collective performance and health of each of the components. For example, the performance and health of the engine, the landing gears, and the like have a crucial role in the performance of an aircraft.

Any malfunction or a faulty operation of such components has a devastating effect on the vehicle and the passengers in the vehicle. As an example, assume that a component, such as a piston in the engine, has been damaged and the damage was not identified in a timely manner. During the operation of the aircraft, if the damage causes failure of the engine, the aircraft may malfunction and thereby, safety of the passengers may be compromised. Accordingly, in order to maintain the reliability and safety of the components of the vehicle, components of the vehicle are subjected to periodic diagnosis. For example, components are periodically inspected for any malfunctions and are replaced or repaired.

In the present subject matter, a system for detection of anomalies in a component may include a processing unit. The processing unit may obtain, from a plurality of sensors corresponding to the component, one or more detection parameters. The plurality of sensors may be configured to continuously capture the one or more detection parameters during operation of the component, wherein the component is a part of an aerial vehicle. In an example, the component may correspond to moving parts of the aerial vehicle. The processing unit may process the one or more detection parameters. The processing unit may include extraction of a set of detection features corresponding to the one or more detection parameters. The processing unit may ascertain, using an analysis model, a plurality of spectral representations corresponding to the extracted set of detection features. The processing unit may determine, using the analysis model, an anomaly in operation of the component based on the plurality of spectral representations. The processing unit may identify, using the analysis model, a type of anomaly in the operation of the component and a cause of anomaly in the operation of the component. The analysis model may be trained to determine the anomaly and identify the type of anomaly in the operation of the component and the cause of the anomaly in the operation of the component based on a plurality of baseline spectral representations. The plurality of baseline spectral representations may correspond to an optimal working condition of the component. The processing unit may trigger an alert in response to the detection of anomaly in operation of the component. Further, the processing unit may provide one or more recommendations to address the anomaly. Implementation of the one or more recommendation may be intended to restore the component to the optimal working condition of the component.

Using the analysis model, the processing unit may also determine a location of the anomaly within the component. In an example, prior to the processing of the obtained one or more detection parameters from the plurality of sensors, the processing unit may preprocess the one or more detection parameters. To preprocess, the processing unit may apply, using the analysis model, a plurality of noise reduction techniques and signal normalization techniques.

In an example, the one or more detection parameters may include at least one of a set of acoustic parameters, a set of vibration parameters, and a set of spatial origin parameters. Further, in an example, the plurality of spectral representations comprises at least one of: a set of spectrograms, a set of frequency-domain features, and temporal dependencies corresponding to vibration of the component. In an example, the analysis model may be, for example, an Artificial Intelligence (AI)-based model.

In an example, a set of inputs to configure the one or more detection parameters may be received by the processing unit from a user. The processing unit may set the one or more detection parameters based on the inputs received from the user. The processing unit may obtain, using the analysis model, a plurality of reference detection parameters. The plurality of reference detection parameters may correspond to the one or more detection parameters in the optimal working condition of the component. The processing unit may generate, using the analysis model, the plurality of baseline spectra and may obtain, from the plurality of sensors, the one or more detection parameters captured during operation of the component upon the generation of the plurality of baseline spectra.

The processing unit may obtain, from a set of users corresponding to the aerial vehicle, feedback regarding the alert and the one or more recommendations. The processing unit may update the analysis model based on the feedback and a new operational data corresponding to the one or more detection parameters.

In an example, a method for detection of anomalies in a component may include sending, by a data acquisition unit of an aerial vehicle, multi-modal data corresponding to an engine of the aerial vehicle in real-time. The engine may propel the aerial vehicle. The data acquisition unit may continuously capture the multi-modal data during operation of the engine. The multi-modal data may be received by a processing unit through a secure gateway. The multi-modal data may be filtered by the processing unit by using an analysis model. A set of detection features corresponding to the multi-modal data may be extracted, by the processing unit, from the filtered multi-modal data using the analysis model. The set of detection features may be analysed using the analysis model, by the processing unit, to obtain a composite anomaly signature corresponding to the multi-modal data. The composite anomaly signature corresponding to the multi-modal data may be processed, by the processing unit, using the analysis model to ascertain an anomaly in the operation of the engine based on the analysis. The anomaly may be classified, by the processing unit, into one of a set of predefined anomalies using the analysis model based on the processing. A cause of the anomaly may be identified, by the processing unit, based on the processing. A spatial origin of the anomaly may be determined by the processing unit by using the analysis model based on the processing. The analysis model may be trained to ascertain the anomaly, to classify the anomaly, and to identify the cause of the anomaly based on a plurality of reference detection parameters corresponding to an optimal working condition of the engine. A customized alert may be received, from the processing unit, by at least one stakeholder corresponding to the aerial vehicle. The customized alerts may be indicative of the presence of the anomaly in the operation of the engine, the classification of the anomaly, the cause of the anomaly, and the spatial origin of the anomaly in response to the detection of anomaly in operation of the component. One or more customized recommendations to address the anomaly may be received, from the processing unit, by the at least one stakeholder corresponding to the aerial vehicle. Implementation of the one or more recommendation is intended to restore the component to the optimal working condition of the engine.

In an example, a non-transitory computer-readable medium may include instructions for detection of anomalies in a component. The instructions may be executable by a processing resource to train an analysis model with a plurality of reference detection parameters to enable determination of presence of an anomaly in an engine of an aerial vehicle, a type of anomaly, a cause of an anomaly, and a spatial origin of the anomaly. The component corresponds to the engine of the aerial vehicle. The engine may propel the aerial vehicle. The plurality of reference detection parameters may correspond to an optimal working condition of the engine. The analysis model may be, for example, an Artificial Intelligence (AI)-based analysis model.

The instructions may be executable by the processing resource to receive, from a data acquisition unit of the aerial vehicle, multi-modal data corresponding to the engine of the aerial vehicle in real-time. The data acquisition unit may continuously capture the multi-modal data during operation of the aerial vehicle. The instructions may be executable may apply, using the trained analysis model, noise filtering techniques on the multi-modal data to enhance quality of the multi-modal data. The instructions may be executable by the processing resource to process, using the trained analysis model, the filtered multi-modal data to obtain a set of detection features corresponding to the multi-modal data. The instructions may be executable by the processing resource to determine, using the trained analysis model, a composite anomaly signature corresponding to the multi-modal data based on an analysis of the set of detection features. Using the trained analysis model, it may be identified whether there is an anomaly in the operation of the engine based on the determination of the composite anomaly signature. Further, using the trained analysis model, a type of the anomaly, a cause of the anomaly, and a spatial origin of anomaly may be deduced in response to the identification of presence of the anomaly in the operation of the engine. The instructions may be executable by the processing resource to trigger an alert to at least one stakeholder corresponding to the aerial vehicle. The alert may be indicative of the anomaly in the operation of the engine, the type of the anomaly, the cause of the anomaly, and the spatial origin of the anomaly. The instructions may be executable by the processing resource to generate one or more recommendations to address the anomaly. Implementation of the one or more recommendation is intended to restore the component to the optimal working condition of the engine. One or more inputs regarding the alert and the one or more recommendations may be received from the at least one stakeholder. The instructions may be executable by the processing resource to update the analysis model in response to the one or more inputs from the at least one stakeholder and a new multi-modal data and to store the updated analysis model in a database. The updated analysis model may be usable for the anomaly detection in the engine.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a system for detection of anomalies in a component, according to an example implementation of the present subject matter.

FIG. 2 illustrates a system for detection of anomalies in components, according to an example implementation of the present subject matter.

FIG. 3 illustrates a system for detection of anomalies in a component, according to an example implementation of the present subject matter.

FIGS. 4a-4b illustrate a method for detection of anomalies in a component, according to an example implementation of the present subject matter.

FIG. 5 illustrates a method for training of an analysis model for use in detection of anomalies in a component, according to an example implementation of the present subject matter.

FIG. 6 illustrates a method of configuring an analysis model in detection of anomalies in a component, according to an example implementation of the present subject matter.

FIGS. 7a-7b illustrate a method for detection of anomalies in a component, according to an example implementation of the present subject matter and

FIGS. 8a-8b illustrate a computing environment, implementing a non-transitory computer-readable medium for detection of anomalies in a component, according to an example implementation of the present subject matter.

### DETAILED DESCRIPTION

Conventionally, detection and classification of anomalies in the components of a vehicle are performed on a periodic basis. For instance, in the field of aviation, detection and classification of anomalies in the components of the aerial vehicle are performed on a periodic basis. In other words, conventionally, diagnostics of malfunction in aircraft components relies heavily on scheduled maintenance, inspection, and time-bound replacements of components. For example, at regular intervals, components of the aircraft may be subjected to inspection and maintenance activities. In some scenarios, the components may be replaced after serving for an optimal replacement time. The approach of scheduled maintenance and inspection (along with the replacement) is systematic. However, such an approach results in unnecessary maintenance. Accordingly, such an approach may result in unnecessary down time and unnecessary replacement of components.

Further, in the conventional approaches of scheduled inspections of components, if there are issues that are developed by the components between one inspection and a subsequent inspection, the issues may be missed. Accordingly, the conventional techniques result in delayed identification or missing critical faults. Further, the conventional techniques are heavily dependent on manual inspections. Accordingly, conventional techniques rely on the expertise of the personnel and thereby may be inaccurate sometimes.

With the progress in aviation technologies, the aircrafts have become more advanced with components that are complex in design and assembly. Therefore, use of conventional techniques for such advanced components has become difficult. For example, due to intricate design and dependencies on other systems, advanced components necessitate more advanced diagnostic methods. Especially, in case of fault detection and classification of aircraft engines, the conventional techniques of detection and classification of fault may be inadequate and inaccurate.

With the conventional approaches, diagnostics are non-continuous and are not provided in real-time. For instance, as mentioned earlier, the existing techniques for fault detection and classification are done on a periodic basis with a scheduled downtime. Therefore, the conventional approaches can lead to delayed fault detections with increased safety risks and operational disruptions. A long-haul flight might experience changes in the performance of the engine that might fall within acceptable ranges per traditional monitoring systems. However, such performance changes may be early indicators of issues that could be serious in the long run. Without the real-time analysis, such early indicators of a developing problem may not be noticed.

In the conventional scenarios, only broad fault detection is made without specifically identifying the faulty components and the nature of faults. Therefore, such conventional approaches lead to increased downtime, increased repair cost, and potential safety risks. In addition, in some scenarios, such approaches also lead to unnecessary replacements of components. For instance, during a scheduled maintenance of an aircraft, assume that maintenance personnel had detected an abnormal vibration in the engine. However, since the maintenance personnel will not be able to identify the location or the cause of the abnormal vibration, multiple components may need to be inspected and potentially be replaced.

Further, the conventional techniques fail to accurately predict engine health or failure of engine proactively. For example, a sub-part of the engine may be approaching failure that may not be captured by traditional techniques. This may lead to unexpected failures despite adherence to maintenance schedules. In some scenarios, the diagnostic methods involve disassembly of the engine or other components. However, such disassembly may not be required in all cases. Therefore, such unnecessary disassembly may increase the downtime and increase the overall cost.

The present subject matter facilitates detection of anomalies in components. In particular, the present subject matter facilitates detection of anomalies in engines of aerial vehicles. With the present subject matter, anomalies of the engines in the aerial vehicles, including the types, causes, and the locations of the anomalies, can be continuously determined and in real-time. In addition, with the present subject matter, alerts and recommendations to address the anomalies are also provided. Therefore, the present subject matter provides improved safety, enhanced efficiency, reduced cost, reduced downtime, and eliminates unnecessary replacement of components.

In an example, the present subject matter relates to techniques for detecting anomalies in components. In particular, the present subject matter relates to techniques for detection of anomalies in engines of aerial vehicles. Hereinafter, the component will be explained with reference to an engine of an aerial vehicle. The techniques include a data acquisition unit that has a plurality of sensors integrated at various locations in the aerial vehicle relative to the engine. The sensors continuously capture data during the operation of the aerial vehicle. The sensors collect multi-modal data including acoustic parameters, vibration parameters, and angle of noise parameters (to identify spatial origin of anomaly). In an example, the sensors to collect acoustic parameters may be microphones, the sensors to collect vibration parameters may be accelerometers, and the sensors to collect through angle of noise may be position sensors. In an example, the angle of noise may be derived from an array of microphones or can be collected through other types of sensors.

The multi-modal data may be obtained by a processing unit in real-time through a secure gateway. As will be understood, the real-time here refers to instance corresponding to operation of the aerial vehicle and thereby, operation of the engine. Further, noise filtering techniques signal normalization techniques are applied to the multi-modal data as a part of preprocessing. The preprocessed data undergoes feature extraction to obtain a set of detection features, which may include frequency components, amplitude variations, and temporal patterns of sound and vibration.

An analysis model is employed to analyze and process these features. The analysis model may be, for example, an Artificial Intelligence (AI)-based analysis model, such as a neural network, Convolutional Neural Network (CNN), Recurrent Neural Network (RNN), or a combination thereof. The analysis model, such as the CNN, analyzes these features to identify spectral signatures. In an example, the spectral signature may include spectrograms and frequency-domain features. In another example, the analysis model, such as the RNN, may analyze these features to determine temporal signature (temporal dependencies and patterns) of the multi-modal data. In a further example, both the spectral signature and the temporal signature may be determined. In such an example, a hybrid model, such as the combination of the CNN and RNN, may be used for the determination of the spectral and the temporal signature.

During operation, the analysis model may compare the current composite anomaly signature (the spatial signature, the temporal signature, or the combination thereof) with a baseline data to detect anomalies, classify their types, identify their causes, and determine their spatial origin within the component. In this regard, the analysis model may be trained using reference detection parameters corresponding to optimal working conditions of the component. The training process involves generating baseline and test anomaly signatures, comparing them, and iterating to achieve predetermined accuracy in anomaly classification and identification of cause of the anomaly.

Upon detecting an anomaly, customized alerts may be triggered to relevant stakeholders, such as pilots, maintenance personnel, operators, engine suppliers, and the like. The alerts may indicate the presence, type, cause, and location of the anomaly. Additionally, recommendations to address the anomaly, aiming to restore the engine to an optimal working condition, may be provided. In cases where there is no anomaly detected, alerts may not be generated.

The present subject matter covers a wide range of anomaly types, including abnormal vibrations, various engine sounds (such as knocking, clanking, hissing, squealing), and excessive heat. It can identify numerous causes, including wear or damage to engine parts, pre-ignition, detonation, air leaks, cooling system issues, and problems with belts, pulleys, bearings, or the turbocharger.

In an example, instead of automatically identifying the anomaly based on the sound, vibration, and angle-of-noise parameters, the present subject matter may allow a user, such as an airliner, a maintenance personnel, a pilot, and the like, to configure the detection parameters for detecting the anomaly. In this regard, users can input settings to configure the detection parameters. Based on the inputs received, the detection parameters can be set. In such scenarios, for the detection, a plurality of reference detection parameters corresponding to optimal working conditions are also obtained. In response, baseline data may be generated using the reference detection parameters.

In another example, the analysis model is adaptively updated to improve the performance and the accuracy of the detection of the anomaly. In this regard, feedback from various stakeholders is incorporated. Further, the analysis model may be updated based on the feedback and new operational data, with the updated model being stored for future use. This allows for ongoing refinement and adaptation of the anomaly detection capabilities.

The present subject matter aims to enhance the reliability and performance of components, such as engine of aircrafts, through continuous monitoring, real-time analysis, and proactive maintenance. The present subject matter enables prognostic detection of anomalies and thereby, increasing the life span of the components. By combining multi-modal data analysis, advanced machine learning techniques, and stakeholder engagement, the present subject matter provides a robust solution for detecting and addressing anomalies in critical components of aerial vehicles. With the present subject matter, the accuracy of fault detection and classification is enhanced. For instance, by using adaptive learning of AI-based models to analyze spatial and temporal patterns in the sensor data, the present subject matter offers high accuracy in identifying and categorizing engine faults, reducing misdiagnoses, and unnecessary maintenance. Since the present subject matter continually learns and updates the analysis model, the present subject matter enables identification of new fault patterns. By using angle-of-noise data, the present subject matter identifies the exact location of the fault within the engine. Therefore, the present subject matter eliminates the cumbersome and complex process of identification of the location of the fault manually by the maintenance personnel. Therefore, the present subject matter streamlines maintenance and repair processes.

With the present subject matter, sensors are used to identify data about health and performance of the engine. Therefore, with the present subject matter, the process of disassembly to assess engine health and performance is eliminated. Accordingly, the present subject matter reduces downtime and maintenance costs. The present subject matter can forecast potential faults and failure and thereby allowing proactive maintenance and reducing unscheduled downtimes. The present subject matter provides customized alerts and recommendations to various stakeholders involved in aircraft maintenance and operation. By detecting faults early, the present subject matter enhances safety and reduces the risk of in-flight engine failures, and the related damages caused to the passengers.

With the present subject matter, security of data is ensured. The present subject matter allows user, such as airlines, maintenance personnel, manufacturers of components, and the like, to configure the detection parameters and enable identification of the anomaly in-house. In other words, the users may not have to share the data of the aircraft to perform the detection or to update the analysis model regularly. In addition, the transmission of the sensor data from the aircraft is also performed through a secure gateway. Therefore, the present subject matter ensures enhanced security of data, which is critical in the field of aviation.

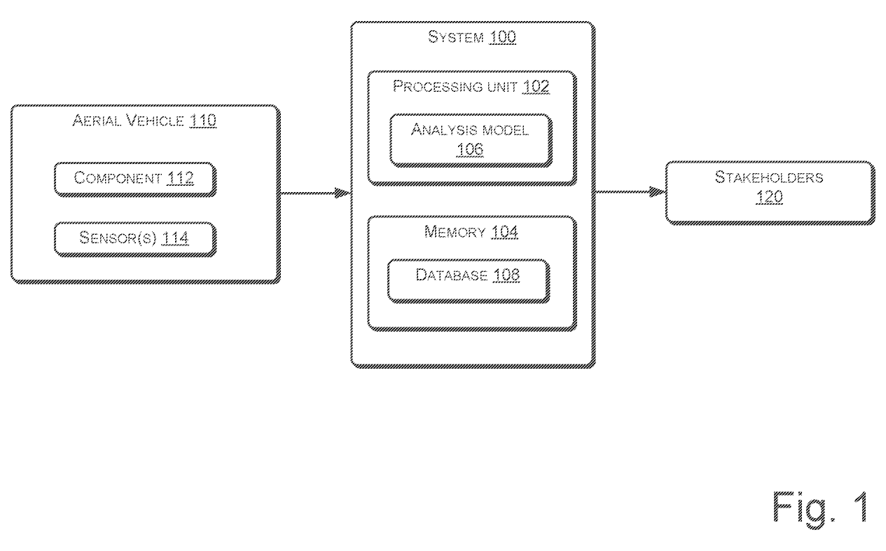

The present subject matter is further described with reference to FIGS. 1-8b. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for detection of anomalies in a component, according to an example implementation of the present subject matter. A Vehicle, such as an aerial vehicle 110, may include a component 112 to enable operation thereof. The component 112 may be, for example, engine, landing gears, flight control units, ignition units, air-conditioning systems, and the like. In an example, the component 112 may correspond to moving component of the aerial vehicle 110.

Further, in an example, the aerial vehicle 110 may include a plurality of sensors 114 to monitor various parameters corresponding to the aerial vehicle 110. In an example, the plurality of sensors 114 may be configured to continuously capture one or more detection parameters during operation of the aerial vehicle 110 (and thereby the operation of the component 112). The detection parameters may be parameters that will enable detection of the anomaly in the component 112. The plurality of sensors 114 may, for example, include air data sensors, pitot tube, Attitude and Heading Reference units, Inertial Measurement Unit (IMU) to measure orientation and position, Global Positioning Satellite (GPS) receiver, magnetometer, gyroscope, altimeter, temperature sensors, load cells, proximity sensors, Radar systems, imaging sensors, Light Detection and Ranging (LIDAR), Infrared (IR) sensors, ultrasonic sensors, fuel flow sensors, oxygen sensors, air quality sensors, Angle of Attack sensors, weight on wheels sensors, acoustic sensors, vibration sensors, and the like. For instance, the acoustic sensors may measure sound corresponding to the component 112 of the aerial vehicle 110. The vibration sensors may measure vibration corresponding to the component 112 of the aerial vehicle 110.

In an example, anomalies in the component 112 may have to be detected to ensure reliable and safe operation of the component 112. In particular, anomalies in the working of the component 112 may have to be detected earlier to monitor health of the component 112 prognostically. In this regard, the system 100 may detect anomalies in the component 112. The system 100 may include a processing unit 102 and a memory 104. The processing unit 102 may include a microprocessor, a microcomputer, a microcontroller, a digital signal processor, a central processing unit, a state machine, a logic circuitry, or a device that manipulates signals based on operational instructions. Among other capabilities, the processing unit 102 may fetch and execute computer-readable instructions stored in the memory 104. The memory 104 may include a volatile memory or a non-volatile memory. The memory 104 may include a database 108 to store various data. For instance, the database 108 may store real-time data captured by the sensors 114, historical data captured by the sensors 114, reference parameters corresponding to the detection, baseline spectral representation, and the like.

The processing unit 102 may include an analysis model 106 generated by the processing unit 102. The processing unit 102 may use the analysis model 106 to detect the anomaly in the component 112 perform various activities, as will be explained in detail later. The analysis model 106 may be an Artificial Intelligence (AI)-based model. In particular, the analysis model 106 may include a neural network, Convolutional Neural Network (CNN), Recurrent Neural Network (RNN), such as a Long Short-Term Memory (LSTM), or a combination thereof.

In an example, using the analysis model 106, the processing unit 102 may obtain one or more detection parameters from the plurality of sensors 114. The one or more detection parameters may either be selected automatically or based on inputs from the at least one stakeholder 120. The processing unit 102 may process the one or more detection parameters. For example, the processing unit 102 may extract a set of detection features corresponding to the one or more detection parameters. The detection features may be features that correspond to the detection parameters that may enable detection of the anomaly in the component 112. Further, the processing unit 102 may use the analysis model 106 to ascertain a plurality of spectral representations corresponding to the extracted set of detection features.

Using the analysis model 106, the processing unit 102 may determine an anomaly in operation of the component 112 based on the plurality of spectral representations. In addition, the processing unit 102 may use the analysis model 106 to identify a type of anomaly in the operation of the component 112 and a cause of anomaly in the operation of the component 112. To perform the detection, the analysis model 106 may be trained. In addition, the analysis model 106 may be trained to identify the type of anomaly and the cause of the anomaly in the operation of the component 112 based on a plurality of spectral representations corresponding to an optimal working condition of the component 112. The plurality of spectral representations corresponding to the optimal working condition of the component 112 will be referred to as “plurality of baseline spectral representations”. For example, the anomaly and the type and the cause of the anomaly may be identified by comparing the plurality of spectral representations corresponding to the one or more detection parameters and the plurality of baseline spectral representations.

In an example, the processing unit 102 may trigger an alert in response to the detection of anomaly in operation of the component 112. The alert may be indicative of the anomaly in the operation, the type of the anomaly, the cause of the anomaly, or a combination thereof. The alert may be provided to at least one stakeholder 120 corresponding to the aerial vehicle 110. The at least one stakeholder 120 may include one or more pilots of the aerial vehicle 110, maintenance personnel corresponding to the component 112 of the aerial vehicle 110, operator of the aerial vehicle 110, manufacturer of the component 112 of the aerial vehicle 110, or a combination thereof. Options, such as the mode of triggering the alert, timing of triggering the alert, time duration of the alert, and the like, may be chosen automatically or may be configured by the at least one stakeholder 120.

Further, the processing unit 102 may use the analysis model 106 to provide one or more recommendations to address the anomaly. For instance, the recommendations may include instructions which, when implemented, may intend to restore the component 112 to the optimal working condition of the component 112. As an example, assume that the processing unit 102 has determined anomaly in the operation of pistons of an engine of the aerial vehicle 110. Further, assume that the processing unit 102 has identified the type of the anomaly as the piston wear and the cause of the anomaly as physical damage from debris or operational stress. In such a scenario, the processing unit 102 may trigger an alert to the at least one stakeholder 120 indicating that there is an anomaly in the operation of the pistons and that the type of the anomaly is piston wear. In addition, the alert may indicate the cause as physical damage from debris and operation stress. The processing unit 102 may recommend inspection of pistons for wear and recommend replacement of the pistons if required. Options, such as the mode of providing the recommendations, type of recommendations to be provided to each stakeholder 120 (in case of multiple stakeholders 120), timing of providing the recommendations, and the like, may be chosen automatically or may be configured by the at least one stakeholder 120.

While in the above example, the system 100 is explained with reference to the detection of an anomaly in a single component, in other examples, detection of anomalies in multiple component 112 can be performed simultaneously, as will be explained below.

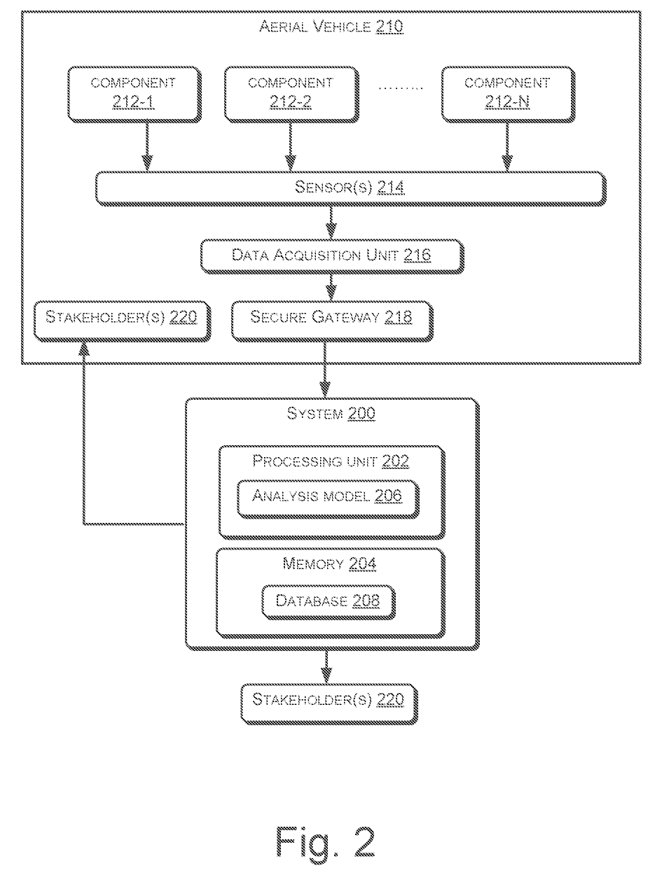

FIG. 2 illustrates a system 200 for detection of anomalies in components, according to an example implementation of the present subject matter. The aerial vehicle 210 may correspond to the aerial vehicle 110. For instance, the aerial vehicle 210 may include a plurality of components 212-1…212-N, which correspond to the component 112, as explained with reference to FIG. 1. Each of the components 212-1, …, 212-N, may be Line Replaceable Units (LRU). The components 212-1, 212-2,…212-N may, for example, include engine, landing gears, flight control units, ignition units, air-conditioning systems, and the like. In other words, the component 212-1 may be an engine, the component 212-2 may be landing gears, and so on. The components 212-1,…, 212-N may correspond to moving components of the aerial vehicle 110.

The aerial vehicle 210 may include a plurality of sensors 214 to monitor various parameters corresponding to the aerial vehicle 210. The plurality of sensors 214 may correspond to the plurality of sensors 114 of the aerial vehicle 110. The plurality of sensors 114 may be configured to continuously capture one or more detection parameters during operation of the aerial vehicle 110 (and thereby the operation of each of the components 212-1, 212-2,…212-N). The plurality of sensors 114 may, for example, include air data sensors, pitot tube, Attitude and Heading Reference units, Inertial Measurement Unit (IMU) to measure orientation and position, Global Positioning Satellite (GPS) receiver, magnetometer, gyroscope, altimeter, temperature sensors, load cells, proximity sensors, Radar systems, imaging sensors, Light Detection and Ranging (LIDAR), Infrared (IR) sensors, ultrasonic sensors, fuel flow sensors, oxygen sensors, air quality sensors, Angle of Attack sensors, weight on wheels sensors, acoustic sensors, vibration sensors, and the like.

The acoustic sensors may measure sound arising from the components 212-1, 212-2,…212-N of the aerial vehicle 210. The vibration sensors may measure vibration of the components 212-1, 212-2,…212-N of the aerial vehicle 210. The air data sensor may monitor parameters, such as airspeed, altitude, static pressure, and air temperature. The pitot tube may measure dynamic pressure of the aerial vehicle 210. The dynamic pressure of the aerial vehicle 210 may be used to determine speed of the aerial vehicle 210. Attitude and Heading Reference units may measure attitude (roll, pitch, and yaw) of the aerial vehicle 210 and heading. The IMU may measure acceleration and angular rates to determine orientation and position of the aerial vehicle 210. The GPS receiver may provide accurate positioning and navigation information of the aerial vehicle 210. The magnetometer may measure magnetic field of Earth to determine heading of the aerial vehicle. The gyroscope may measure a rate of rotation around different axes relative to the aerial vehicle 210 to determine the attitude of the aerial vehicle 210. The altimeter may measure altitude of the aerial vehicle 210 based on atmospheric pressure variations. The temperature sensors may monitor temperature variations with the components 212-1, 212-2,…212-N of the aerial vehicle 210. The load cells may measure forces and loads experienced the components 212-1, 212-2,…212-N, such as wings, landing gear, and the like. The proximity sensor may detect presence or distance of objects. The Radar unit may detect and track objects, including other aerial vehicles and terrain. The imaging sensors may capture visual data. The LIDAR may measure distance using Light Amplification by Stimulated Emission of Radiation (LASER) light source. The IR sensors may detect thermal radiation. The ultrasonic sensors may measure distance using sound waves. The fuel flow sensors may measure rate of fuel consumption. The oxygen sensors may monitor oxygen levels in cabin environments. The air quality sensors may measure parameters, such as carbon dioxide and the like, to ensure a safe cabin environment in the aerial vehicle 210. The angle of attack sensors may measure angle between a longitudinal axis of the aerial vehicle and a wind direction relative to the aerial vehicle 210. The weight on wheels sensors may determine whether the aerial vehicle 210 may be on ground or in-flight.

The acoustic sensors may detect and measure sound arising from the components 212-1, 212-2,…212-N. In an example, the acoustic sensors may include microphones, omnidirectional sensors, directional acoustic arrays, long-range acoustic sensors, and the like. The vibration sensors may detect and measure vibration of the components 212-1, 212-2,…212-N. The vibration sensors may include accelerometers, such as piezoelectric accelerometers, Micro-Electro-Mechanical Systems (MEMS) accelerometers, and the like, Integrated Electronics Piezoelectric (IEPE) Sensors, displacement sensors, vibration analyzers, and the like. In addition, the plurality of sensors 214 may include position sensors to enable determination of spatial origin of the noise. The position sensors may, for example, include linear position sensors, rotary position sensors, float operated sensors, angle transmitters, and the like. The proximity sensors may be used as position sensors. Each of the plurality of sensors 214 may be positioned at a plurality of predetermined locations.

The parameters monitored by the plurality of sensors 214 may be transmitted obtained by a data acquisition unit 216 of the aerial vehicle 210. The data acquisition unit 216 may transmit the obtained parameters from the plurality of sensors 214 to the system 200 for the detection. As will be understood, the data acquisition unit 216 may transmit the parameters monitored by the plurality of sensors 214 in real-time and continuously to the system 200. In addition, the aerial vehicle 210 may include a secure gateway 218 through which the monitored parameters can be transmitted to the system 200 securely. In another example, the parameters can be transmitted by the data acquisition unit 216 to a centralized database (not shown in FIG. 2) through the secure gateway 218. The centralized database may be, for example, a part of Internet of Things (IoT) platform, such as Honeywell Forge. In such a scenario, the system 200 may fetch the monitored parameters from the centralized database and store in a database 208 of the system 200. In another example, the system 200 may be part of the IoT platform. In yet another example, the system 200 may correspond to the IoT platform.

In an example, anomalies of the components 212-1, 212-2,…212-N may have to be detected to simultaneously and in real-time to ensure reliable and safe operation of the components 112. In particular, the components 212-1, 212-2,…212-N may have to be monitored continuously and the anomalies in the working of the components 212-1, 212-2,…212-N may have to be detected earlier to monitor health of the components 212-1, 212-2,…212-N proactively. In this regard, the system 200 may detect anomalies in the components 212-1, 212-2,…212-N simultaneously. The system 200 may include a processing unit 202 and a memory 204. The system 200 may correspond to the system 100. The processing unit 202 may correspond to the processing unit 102. The memory 204 may correspond to the memory 104.

The processing unit 202 may include a microprocessor, a microcomputer, a microcontroller, a digital signal processor, a central processing unit, a state machine, a logic circuitry, or a device that manipulates signals based on operational instructions. Among other capabilities, the processing unit 202 may fetch and execute computer-readable instructions stored in the memory 204. The memory 204 may include a volatile memory or a non-volatile memory. The memory 204 may include the database 208 to store various data, such as real-time parameters monitored by the plurality of sensors 214, historical data monitored by the plurality of sensors 214, reference parameters corresponding to the detection, baseline spectral representation, and the like.

The processing unit 202 may include an analysis model 206 generated by the processing unit 202. The processing unit 202 may use the analysis model 206 to detect the anomaly in the components 212-1, 212-2,…212-N simultaneously. The analysis model 206 may be an AI-based model. In particular, the analysis model 206 may include a neural network, Convolutional Neural Network (CNN), Recurrent Neural Network (RNN), such as a Long Short-Term Memory (LSTM), or a combination thereof. The analysis model 206 may correspond to the analysis model 106.

In an example, using the analysis model 206, the processing unit 202 may obtain one or more detection parameters from the plurality of sensors 114 corresponding to each of the components 212-1, 212-2,…212-N. The processing unit 202 may process the one or more detection parameters. For example, the processing unit 202 may extraction a set of detection features corresponding to the one or more detection parameters corresponding to each of the components 212-1, 212-2,…212-N. The detection features may be features that correspond to the detection parameters that may enable detection of the anomalies in each of the components 212-1, 212-2,…212-N. Further, the processing unit 202 may use the analysis model 206 to ascertain a plurality of spectral representations corresponding to the extracted set of detection features. The plurality of spectral representations may include one or more spectral representations corresponding to each of the plurality of components 212-1, 212-2,…212-N.

Using the analysis model 206, the processing unit 202 may determine whether there is an anomaly in operation of each of the plurality of components 212-1, 212-2,…212-N based on the plurality of spectral representations. In other words, the processing unit 202 may analyze one or more spectral representations corresponding to each of the plurality of components 212-1, 212-2,…212-N to determine whether there is an anomaly in the corresponding component of each of the plurality of components 212-1, 212-2,…212-N. If it is determined that there is anomaly in one or more of the components 212-1, 212-2,…212-N, the processing unit 202 may use the analysis model 206 to identify a type of anomaly in the operation of the corresponding component of the plurality of components 212-1, 212-2,…212-N, a cause of anomaly in the operation of the corresponding component of the plurality of components 212-1, 212-2,…212-N, a spatial origin of the anomaly in the operation of the corresponding component of the plurality of components 212-1, 212-2,…212-N. For instance, if it is determined that there is an anomaly in the operation of the components, such as engine and landing gears, the processing unit 202 may identify a type of anomaly, a cause of anomaly, and a spatial origin of the anomaly in the operation of the engine and landing gears. As will be understood, the engine may enable propelling of the aerial vehicle 210 and the landing gears may enable landing of the aerial vehicle 210.

To perform the detection of anomaly, the type of anomaly, the cause of anomaly, and the spatial origin of the anomaly, the analysis model 206 may be trained. The analysis model 206 may be trained to detect the anomaly, identify the type of anomaly, the cause of the anomaly, and the spatial origin of the anomaly in the operation of each of the plurality of components 212-1, 212-2,…212-N based on a plurality of spectral representations corresponding to an optimal working condition of the component. For instance, each of the plurality of components 212-1, 212-2,…212-N may have an optimal working condition. The plurality of spectral representations corresponding to the optimal working condition of each of the plurality of the components 212-1, 212-2,…212-N will be referred to as “plurality of baseline spectral representations”.

In an example, the processing unit 202 may generate the plurality of baseline spectral representations corresponding to each of the plurality of components 212-1, 212-2,…212-N. In this regard, the detection parameters corresponding to each of the plurality of components 212-1, 212-2,…212-N in the optimal working condition can be obtained. The detection features of each of the plurality of the components 212-1, 212-2,…212-N may be determined based on the corresponding detection parameters. Further, the plurality of baseline spectral representations corresponding to each of the plurality of components 212-1, 212-2,…212-N may be generated from the corresponding detection features.

The anomaly and the type, the cause, and the spatial origin of the anomaly may be identified by comparing the plurality of spectral representations corresponding to the one or more detection parameters and the plurality of baseline spectral representations of each of the plurality of components 212-1, 212-2,…212-N. For instance, the plurality of spectral representations of the engine may be compared with the plurality of baseline spectral representations of the engine. Similarly, the plurality of spectral representations of the landing gears may be compared with the plurality of baseline spectral representations of the landing gears.

The processing unit 202 may trigger an alert in response to the detection of anomaly in operation of the components 212-1, 212-2,…212-N. The alert may be indicative of the anomaly in the operation, the type of the anomaly, the cause of the anomaly, the spatial origin of the anomaly, or a combination thereof. The alert may be provided to at least one stakeholder 220 corresponding to the aerial vehicle 110. The at least one stakeholder 220 may include one or more pilots of the aerial vehicle 110, maintenance personnel corresponding to the components 112 of the aerial vehicle 110, operator of the aerial vehicle 110, manufacturer of the components 112 of the aerial vehicle 110, or a combination thereof. Options, such as the mode of triggering the alert, timing of triggering the alert, time duration of the alert, and the like, may be chosen automatically or may be configured by the at least one stakeholder 220.

In an example, the processing unit 202 may refrain from triggering any alert if it is determined that there is no anomaly in the operation of the components 212-1,..,212-N. In another example, if it is determined that there is no anomaly in the operation of the components 212-1, 212-2,…212-N, the processing unit 202 may provide an indication to the at least one stakeholder 220 that there is no anomaly in the operation of the components 212-1, 212-2,…212-N.

Further, the processing unit 202 may use the analysis model 206 to provide one or more recommendations to address the anomaly. The recommendations may include instructions which, when implemented, may intend to restore the component to the optimal working condition of the component. In an example, the alerts and the one or more recommendations may be provided on a display device corresponding to the at least one stakeholder 220. In a particular example, the alerts and the one or more recommendations may be provided as a Graphical User Interface (GUI). For instance, the GUI may include a chat box that may provide the one or more recommendations to the at least one stakeholder 220. Based on the one or more recommendations, the at least one stakeholder 220 may be able to chat and receive subsequent inputs. In this regard, the processing unit 202 may use the analysis model to receive user inputs and provide subsequent response to the user. Options, such as the mode of providing the recommendations, type of recommendations to be provided to each stakeholder 220 (in case of multiple stakeholders 220), timing of providing the recommendations, options corresponding to subsequent inputs, and the like, may be chosen automatically or may be configurable by the at least one stakeholder 220. The analysis model 206 may be trained to trigger the alert, provide the recommendations, and facilitate chatting with the at least one stakeholder 220 to provide subsequent inputs.

A few non-limiting examples of the type of the anomaly, the cause of the anomaly, and the corresponding recommendations are explained below. However, as will be understood, the system 200 may detect other anomalies, other types of the anomaly, other causes of the anomaly, and provide other recommendations than the ones listed below. Here, all the examples are explained with reference to the anomaly detection in engine of the aerial vehicle 210. Therefore, the spatial origin of the anomaly is also included while indicating the anomaly, the type of the anomaly, or the cause of the anomaly.

In an example, the anomaly may include abnormal vibrations of a piston of the engine and knocking or clanking sounds associated with the piston. The type of the anomaly may be piston wear and/or piston damage. The cause of the anomaly may be deterioration of pistons due to prolonged use and/or physical damage from debris and/or operational stress. The one or more recommendations in such a scenario may include instructions for inspecting pistons for wear and instructions to replace, if necessary. Further, the one or more recommendations may include instructions to perform a thorough inspection and repair or replace damaged components.

In another example, the anomaly may include knocking sound associated with piston and/or pinging sound associated with the piston. The type of anomaly may include pre-ignition and/or detonation. The cause of the anomaly may include premature combustion of fuel leading to knocking and/or uncontrolled combustion of fuel causing pinging sounds. The one or more recommendations may include instructions to modify fuel mixture and/or ignition timing. The one or more recommendations may include instructions to ensure proper fuel octane levels and instructions to inspect ignition system of the engine.

In yet another example, the anomaly may include hissing noise of the engine. The type of anomaly may include air leaks in the engine and issues in cooling system corresponding to the engine. The cause of anomaly may include leaks in air intake unit of the engine and/or malfunction in the cooling system of the engine. The one or more recommendations in such scenarios may include instructions to check for and seal leakage in the air intake unit and/or instructions to inspect and repair parts of the cooling system.

In a yet further example, the anomaly may include squealing noise of the engine. The type of anomaly may include belt issue, pulley issue, and/or wear of bearing. The cause of the anomaly may include worn belts and pulleys, misaligned belts and pulleys, and/or worn bearings causing squealing. The one or more recommendations may include instructions to examine belts and pulleys for wear and replacement of the belts and the pulleys, if needed. Further, the one or more recommendations may also include instructions to check and replace bearings that show signs of wear.

In another example, the anomaly may include irregular rattling noise of the engine. The type of anomaly may include loose components and component wear. The cause of anomaly may include improperly secured components and/or general wear and tea. The one or more recommendations may include instructions to inspect and to secure loose components or mounts. Further, the one or more recommendations may include instructions to replace worn parts and address underlying issues in the components.

In an example, the anomaly may include high-pitched whining noise of the engine. The type of anomaly may include issues with turbocharger of the engine and/or issues with gearbox of the aerial vehicle 210. The cause of the anomaly may include problems with turbochargers and/or faults in the gearbox and/or related components. The one or more recommendations may include instructions to check for wear in the turbocharges, to check for damage in the turbochargers, to inspect the gearbox for faults and to perform necessary repairs.

In another example, the anomaly may include excessive heat of the engine. The type of anomaly may include cooling system failure and/or engine component overheating. The cause of the anomaly may include malfunctions in cooling system leading to excessive heat and/or overheating of one or more components of the engine. The one or more recommendations may include instructions to inspect the cooling system, to repair the cooling system, and to examine engine components for overheating damage and address any issues.

In addition, the anomaly may also include high-frequency knocking sound of the engine, high-frequency pinging sound of the engine, high-frequency vibration corresponding to knocking of the engine, and hissing vibration of the engine.

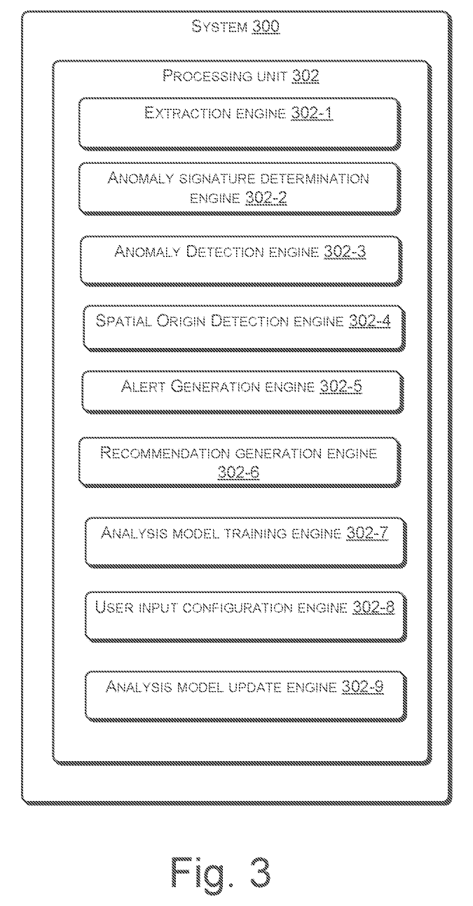

FIG. 3 illustrates a system 300 for detection of anomalies in a component, according to an example implementation of the present subject matter. The system 300 may detect anomalies in a component of an aerial vehicle. The aerial vehicle may correspond to the aerial vehicle 110 or the aerial vehicle 210. The aerial vehicle may include a plurality of components, such as the components 112 or the components 212-1, 212-2,…212-N. The system 300 may correspond to the system 100 or the system 200. The system 300 may be a computing device that has processing capabilities, such as a server, a desktop, a laptop, a tablet, a mobile phone, or the like. For instance, the system 300 may include a processing unit 302. The processing unit 302 may be, for example, a microprocessor, a microcomputer, a microcontroller, a digital signal processor, a central processing unit, a state machine, a logic circuitry or a device that manipulates signals based on operational instructions. Among other capabilities, the processing unit 302 may fetch and execute computer-readable instructions stored in a memory (not shown in FIG. 3), such as a volatile memory or a non-volatile memory, of the system 300. The processing unit 302 may correspond to the processing unit 102 or the processing unit 202. The memory may correspond to the memory 104 or the memory 204.

The processing unit 302 may run at least one operating system and other applications and services, such as a station health service. The system 300 can also include an interface (not shown in FIG. 3) and a memory. The processing unit 302, amongst other capabilities, may be configured to fetch and execute computer-readable instructions stored in the memory. The processing unit 302 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 302, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the cloud communication device to interact with different entities, such as the processing unit 302. Further, the interface may enable the components of the system 300 to communicate with other cloud servers, web servers, and external repositories. The interface may facilitate multiple communications within a wide variety of networks and protocol types, including wired network, wireless networks, wireless Local Area Network (WLAN), RAN, satellite-based network, and the like.

The memory may be coupled to the processing unit 302 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory may include a database, such as the database 108 or the database 208. The database may store real-time data captured by a plurality of sensors of an aerial vehicle, historical data captured by the sensors 114, reference parameters corresponding to the detection, baseline spectral representation, and the like.

Further, the system 300 may include one or more engines 302-1-302-9. The engines 302-1-302-9 may include routines, programs, objects, components, data structures, and the like, which perform particular tasks or implement particular abstract data types. Further, the engines 302-1-302-9 may be implemented in hardware, instructions executed by a processing unit, or by a combination thereof.

In an implementation, the engines 302-1-302-9 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 302-1-302-9 may perform different functionalities. The engines 302-1-302-9 may include an extraction engine 302-1, an anomaly signature determination engine 302-2, an anomaly detection engine 302-3, a spatial origin detection engine 302-4, an alert generation engine 302-5, a recommendation generation engine 302-6, an analysis model training engine 302-7, a user input configuration engine 302-8, and an analysis model update engine 302-9.

The extraction engine 302-1 may use an analysis model to preprocess one or more detection parameters that are obtained by the system 300 from a plurality of sensors corresponding to the aerial vehicle. The one or more detection parameters may include a set of acoustic parameters, a set of vibration parameters, and a set of spatial origin parameters. In some scenarios, the one or more detection parameters may include additional parameters, such as weight on wheels, and the like. The preprocessing may include application of a plurality of noise reduction techniques and signal normalization techniques on the one or more detection parameters that are obtained to enhance data quality. The extraction engine 302-1 may process the one or more detection parameters to extract a set of detection features corresponding to the one or more detection parameters using the analysis model. The set of detection features may include frequency components, variation of amplitude, temporal patterns of sound, temporal patterns of vibration, or a combination thereof. The analysis model may correspond to the analysis model 106 or the analysis model 206.

The anomaly signature determination engine 302-2 may include ascertaining an anomaly signature corresponding to the set of detection features using the analysis model. The anomaly signature may include a plurality of temporal patterns corresponding to the set of detection features and a plurality of spectral representations corresponding to the set of detection features. In particular, the plurality of spectral representations may include a set of spectrograms and a set of frequency-domain features. The temporal patterns may include temporal dependencies corresponding to vibration of the components. Therefore, the anomaly signature may alternatively be referred to as “composite anomaly signature”.

The anomaly detection engine 302-3 may determine whether there is an anomaly in operation of the component based on the anomaly signature. The anomaly detection engine 302-3 may perform the determination using the analysis model. Further, the anomaly detection engine 302-3 may also determine a type of anomaly in the operation of the component and a cause of anomaly in the operation of the component.

The spatial origin detection engine 302-4 may determine the location of the anomaly within the component using the analysis model based on the determination of the anomaly. In other words, the spatial origin detection engine 302-4 may determine a spatial origin of the anomaly within the component in response to the ascertaining that there is an anomaly in the operation of the component.

The alert generation engine 302-5 may include triggering a customized alert to be transmitted to at least one stakeholder corresponding to the aerial vehicle. The customized alert may be transmitted using the analysis model in response to the detection of the presence of the anomaly in the operation of the component. The customized alerts may be indicative of the presence of the anomaly in the operation of the engine, the type of the anomaly, the cause of the anomaly, and the spatial origin of the anomaly. In another example, the alert generation engine 302-5 may refrain from triggering any alerts in response to the determination that there is no anomaly in the operation of the component. Further, in another example, the alert generation engine 302-5 may trigger alert or refrain from triggering alerts based on inputs of the at least one stake holder corresponding to the aerial vehicle.

The recommendation generation engine 302-6 may include provision of one or more customized recommendations to address the anomaly. The one or more customized recommendations may be generated by using the analysis model. Implementation of the one or more customized recommendations is intended to restore the component to an optimal working condition of the component. In an example, the recommendation generation engine 302-6 may provide the one or more recommendations based on inputs from the at least one stakeholder corresponding to the aerial vehicle. In other words, the recommendation generation engine 302-6 may provide the one or more recommendations in a way that the at least one stakeholder has configured. Further, in some examples, the recommendation generation engine 302-6 may provide the one or more recommendations as a GUI, such as a chat box. In such scenarios, the recommendation generation engine 302-6 may receive inputs from at least one stakeholder and provide recommendations subsequent to the one or more recommendations based on the inputs received from the user.

The analysis model training engine 302-7 may train the analysis model to perform the detection of the anomaly in the operation of the components. For the training, the analysis model training engine 302-7 may generate a training data anomaly signature based on a training data. The analysis model training engine 302-7 may compare a training data anomaly signature with a baseline anomaly signature of a plurality of baseline anomaly signatures. The plurality of baseline anomaly signatures may correspond to the anomaly signatures of the component in the optimal working condition. The analysis model training engine 302-7 may determine an anomaly in the operation of the component based on the comparison. Further, the analysis model training engine 302-7 may classify the anomaly into one of a set of predefined anomalies. The analysis model training engine 302-7 may identify a cause of the anomaly and a spatial origin of the anomaly. The analysis model training engine 302-7 may compare the detection of the anomaly, the classification of the anomaly, and the spatial origin of the anomaly with a set of reference labels. The set of reference labels may include data indicative of presence of anomaly, the classification of the anomaly, the cause of the anomaly, and the spatial origin of the anomaly of the training data. The analysis model training engine 302-7 may train with a plurality of training data till a predetermined accuracy is achieved. In an example, the analysis model training engine 302-7 may be trained to trigger the alert and to provide the one or more recommendations.

The user input configuration engine 302-8 may enable setting the one or more detection parameters based on inputs received from the at least one stakeholder, such as at least one stakeholder corresponding to the aerial vehicle. The user inputs configuration engine 302-8 may enable configuring triggering of the alerts by at least one stakeholder and configuring provision of the recommendations by the at least one stakeholder. The user input configuration engine 302-8 may enable the at least one stakeholder to provide feedback regarding the alert and the recommendations. The analysis model update engine 302-9 may update the analysis model based on the feedback from the at least one stakeholder and new operational data. The updated analysis model may be used for use in future.

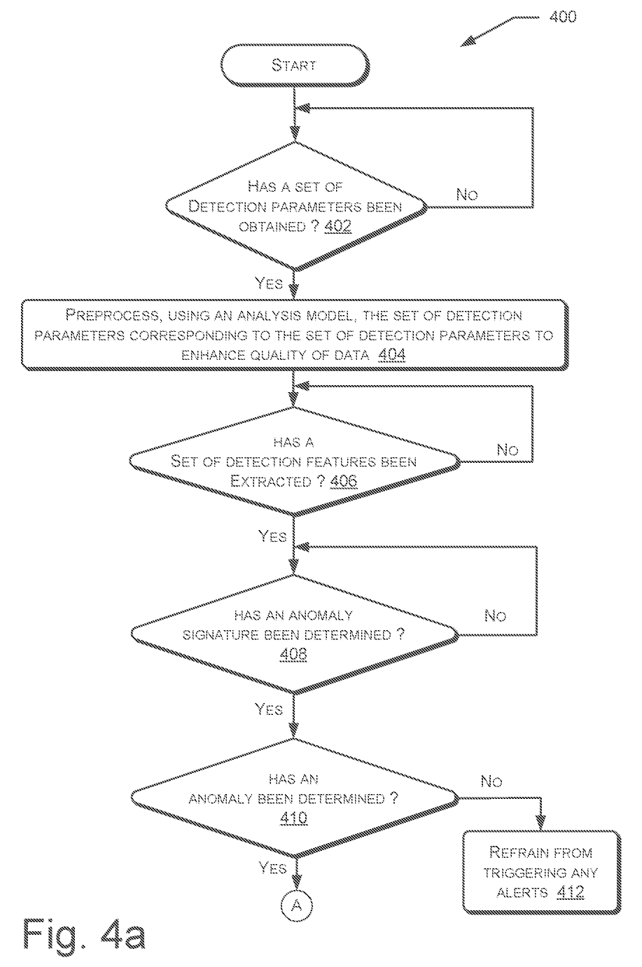

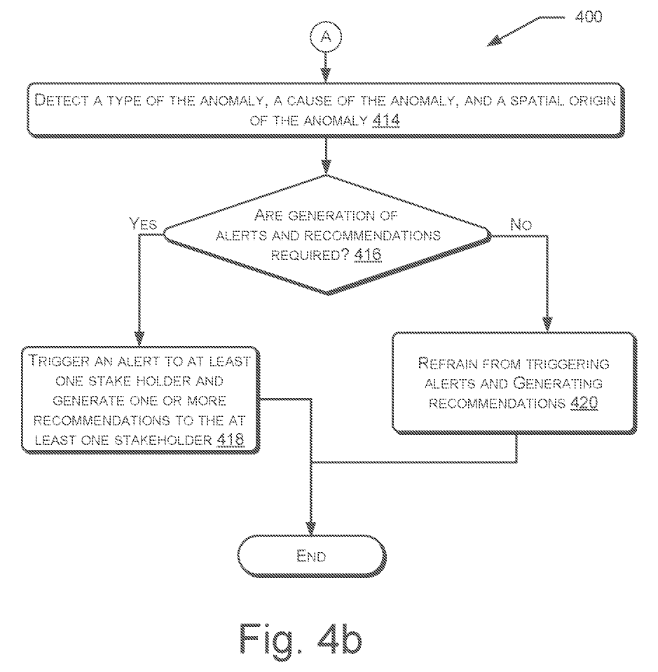

FIGS. 4a-4b illustrate a method 400 for detection of anomalies in a component, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 400 may be performed by the system 100, the system 200 or the system 300. In particular, the method 400 may be performed by the processing unit 102, the processing unit 202, or the processing unit 302. Herein, the method 400 is explained with reference to detection of anomalies in a component of an aerial vehicle. However, the method 400 may detect anomalies in a plurality of components of the aerial vehicle. The aerial vehicle may correspond to the aerial vehicle 110 or the aerial vehicle 210. The component may correspond to the component 112 or a component of the plurality of components 212-1, 212-2,…212-N.

Referring to FIG. 4a, at step 402, it may be determined if a set of detection parameters corresponding to the component has been obtained. The detection parameters may enable detection of the anomaly in the component. The set of detection parameters may be obtained from a plurality of sensors of the aerial vehicle. In particular, the set of detection parameters may be obtained from a data acquisition unit of the aerial vehicle. In this regard, the set of detection parameters may be received by the data acquisition unit from the plurality of sensors. The plurality of sensors may correspond to the sensors 114 or the plurality of sensors 214. The data acquisition unit may correspond to the data acquisition unit 216.

In an example, the set of detection parameters may include a set of acoustic parameters and a set of vibration parameters. The set of acoustic parameters may be obtained by acoustic sensors and the set of vibration parameters may be obtained by vibration sensors. In an example, in addition to the set of acoustic parameters and the set of vibration parameters, the set of detection parameters may include a set of spatial origin parameters. The set of spatial origin parameters may be obtained by position sensors and/or proximity sensors. In another example, the set of spatial origin parameters may be obtained by acoustic sensors. For instance, based on position in which each of the set of acoustic sensors are disposed in the aerial vehicle relative to the component, the set of spatial origin parameters can be detected. Hereinafter, the set of detection parameters will be explained with reference to the set of acoustic parameters, the set of vibration parameters, and the set of spatial origin parameters. As explained above, in this example, the set of detection parameters are explained to include the set of acoustic parameters, the set of vibration parameters, and the set of spatial origin parameters. However, in another example, the set of detection parameters may include other parameters monitored by the plurality of sensors, such as weight-on-wheels parameter, and the like.

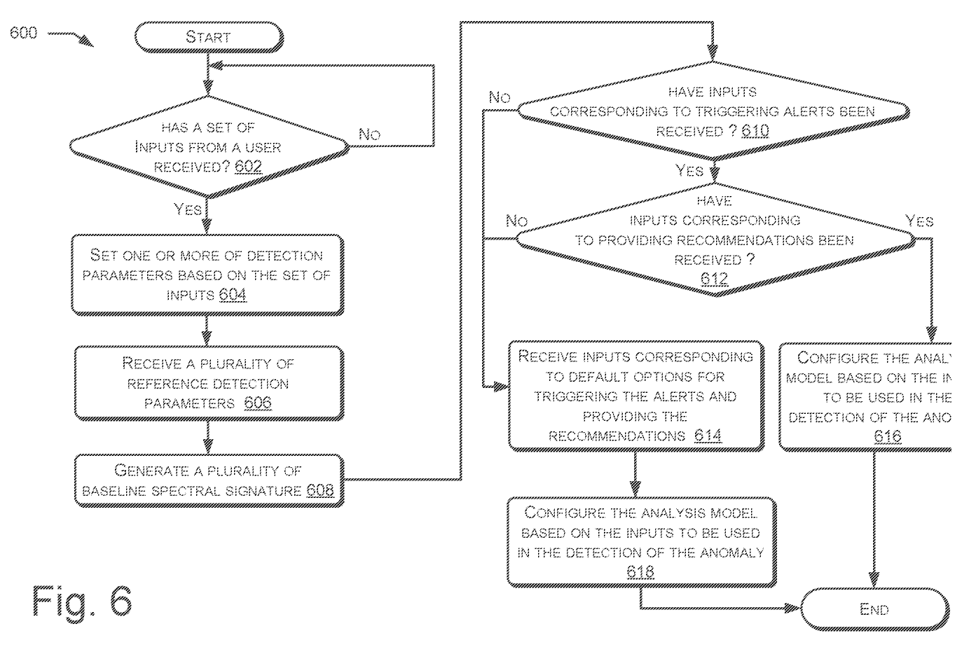

Further, in an example, the detection parameters are set automatically (a default option). However, in another example, the detection parameters can be set by a user, such as at least one stakeholder, such as the stakeholder 120, as will be explained with reference to FIG. 6. Since the set of detection parameters includes various data, such as acoustic parameters, vibration parameters, spatial origin parameters, and the like, the set of detection parameters may be alternatively referred to as “multi-modal data”.

As an example, assume that component is an engine of the aerial vehicle. At step 402, the acoustic parameters, the vibration parameters, and the spatial origin parameters corresponding to the engine monitored by the corresponding sensors may be obtained through the data acquisition unit.

If, at step 402, it is determined that the set of detection parameters have been obtained, the method 400 may proceed to step 404. On the other hand, if it is determined that the set of detection parameters have not been obtained, the method 400 may repeat the step 402 till the detection parameters have been obtained.

At step 404, the set of detection parameters may be preprocessed using an analysis model to enhance quality of data correspond to the set of detection parameters. For instance, to obtain accurate results corresponding to the detection of the anomaly and to have improved performance of the analysis model, the set of detection parameters may be preprocessed. The preprocessing may include profiling of the set of detection parameters to identify quality, structure, and issues with the set of detection parameters. Further, the preprocessing may include identifying and rectifying missing values in the set of detection parameters. The preprocessing may also include removing noisy values in the set of detection parameters. The noise values may be removed by applying a plurality of noise reduction techniques. In other words, irrelevant values in the set of detection parameters may be removed by applying the plurality of noise reduction techniques, thereby enhancing the quality of data. The preprocessing may include applying signal normalization techniques to standardize the set of detection parameters to ensure uniformity.

As an example, the acoustic parameters, the vibration parameters, and the spatial origin parameters corresponding to the engine may be preprocessed using the analysis model to enhance the quality of data.

At step 406, it may be determined if a set of detection features have been extracted. The set of detection features may be extracted using the analysis model. The set of detection features may be extracted from the set of detection parameters. In other words, extraction of the detection features may include reducing dimensionality of the set of detection parameters while retaining much relevant information as possible to detect the anomaly. In an example, the set of detection features may include frequency components, variations of amplitude, temporal patterns of sound, temporal patterns of vibration, or a combination thereof.

As an example, frequency components of the engine, variations of amplitude corresponding to the engine, temporal patterns of sound corresponding to the engine, temporal patterns of vibration corresponding to the engine, or a combination thereof, may be extracted from the preprocessed set of detection parameters.

If, at step 406, it is determined that the set of detection features have been extracted, the method 400 may proceed to step 408. On the other hand, if it is determined that the set of detection features has not been extracted, the method 400 may repeat the step 406 till the set of detection features are extracted.

At step 408, it may be ascertained if an anomaly signature has been determined. The anomaly signature may be determined by using the analysis model. In an example, the anomaly signature may include a plurality of temporal patterns corresponding to the set of detection features and a plurality of spectral representations corresponding to the set of detection features. In particular, the plurality of spectral representations may include a set of spectrograms and a set of frequency-domain features. The temporal patterns may include temporal dependencies corresponding to vibration of the components. Therefore, the anomaly signature may alternatively be referred to as “composite anomaly signature”. In other examples, the anomaly signature may include other patterns. Hereinafter, the anomaly signature may be explained with reference to including the plurality of temporal patterns corresponding to the set of detection features and the plurality of spectral representations corresponding to the set of detection features.

As an example, a plurality of temporal patterns corresponding to the set of detection features of the engine and a plurality of spectral representations corresponding to the set of detection features of the engine may be determined using the analysis model. In other words, a set of spectrograms of the engine, a set of frequency-domain features of the engine, and temporal dependencies corresponding to vibration of the engine may be determined.

At step 408, if it is ascertained that the anomaly signature corresponding to the set of detection features has been determined, the method 400 may proceed to step 410. On the other hand, if the anomaly signature has not been determined, the method 400 may repeat the step 408 till the anomaly signature corresponding to the set of detection features is obtained.

At step 410, it may be ascertained if an anomaly in the component has been determined. The determination of the anomaly in the component may be performed by using the analysis model. In this regard, the anomaly may be determined based on a baseline anomaly signature. The baseline anomaly signature may correspond to an anomaly signature of the component in an optimal working condition of the component. In an example, the baseline anomaly signature may be stored in a database of a memory of the system. The database may correspond to the database 108 or the database 208. The memory may correspond to the memory 104 or the memory 204.

In an example, the baseline anomaly signature may include a plurality of baseline temporal patterns and a plurality of baseline spectral representations. In particular, the plurality of baseline spectral representations may include a set of baseline spectrograms and a set of baseline frequency-domain features. The temporal patterns may include baseline temporal dependencies corresponding to vibration of the component. Therefore, the baseline anomaly signature may alternatively be referred to as “baseline composite anomaly signature”. In other examples, the baseline anomaly signature may include other patterns. Hereinafter, the baseline anomaly signature may be explained with reference to including the plurality of temporal patterns corresponding to the set of detection features and the plurality of spectral representations corresponding to the set of detection features.

The anomaly signature corresponding to the set of detection features may be compared with the baseline anomaly signature. In particular, the set of spectrograms may be compared with the set of baseline spectrograms, the set of frequency-domain features may be compared with the set of baseline frequency-domain features, and temporal dependencies corresponding to the vibration of the component may be compared with the baseline temporal dependencies corresponding to vibration of the component. Based on the comparison, the anomaly in the component may be determined. For instance, if there is any deviation of the anomaly signature from the baseline anomaly signature, the presence of the anomaly may be determined. In other words, it may be identified if there is a deviation of the set of spectrograms from the set of baseline spectrograms, or a deviation of the set of frequency-domain features from the set of baseline frequency-domain features, or deviation of the temporal dependencies from the baseline temporal dependencies. Based on the identification, the presence of the anomaly may be determined. If, based on the comparison, it is identified that there is no deviation, then it may be determined that there is no anomaly in the component.

As an example, assume that there is a deviation in the set of spectrograms of the engine from a set of baseline spectrograms of the engine, or a deviation in the set of frequency-domain features of the engine from a set of baseline frequency-domain features of the engine, or there is a deviation in temporal dependencies corresponding to vibration of the engine from baseline temporal dependencies corresponding to the vibration of the engine. Since there is deviation, it may be determined that there is an anomaly in the operation of the engine. As another example, assume that there is no deviation in the set of spectrograms of the engine from the set of baseline spectrograms of the engine, no deviation in the set of frequency-domain features of the engine from the set of baseline frequency-domain features of the engine, and no deviation in temporal dependencies corresponding to vibration of the engine from the baseline temporal dependencies corresponding to the vibration of the engine. Since there is no deviation, it may be determined that there is no anomaly in the operation of the engine.

At step 410, if it is determined that there is no anomaly, the method 400 may proceed to step 412. On the other hand, if it is determined that there is an anomaly, then the method 400 may proceed to step 414.

At step 412, no alerts may be triggered. In other words, based on the detection that there is no anomaly in the operation of the component, trigger of alerts may be refrained from. As an example, based on the detection that there is no anomaly in the operation of the engine, no alerts may be triggered.

Referring to FIG. 4b, at step 414, in response to the detection of the anomaly, a type of the anomaly, a cause of the anomaly, and a spatial origin of the anomaly may be detected. The type of anomaly, the cause of the anomaly, and the spatial origin of the anomaly may be identified using the analysis model based on the comparison of the anomaly signature with the baseline anomaly signature. Using the analysis model, based on the deviation of the anomaly signature from the baseline anomaly signature, anomaly may be classified into one of a plurality of predefined anomalies. In this regard, the plurality of predefined anomalies may be stored in the database. Further, the cause of the anomaly and the spatial origin may be identified based on the deviation of the anomaly signature from the baseline anomaly signature.

As an example, based on the deviation, the anomaly may be classified as a damage to pistons of the engine. The cause of the anomaly may be determined as physical damage from debris or operational stress. Further, the spatial origin of the anomaly may be determined as one or more locations within the pistons of the engine.

In some scenarios, the at least one stakeholder may prefer to not receive alerts and recommendations. For example, if the anomaly is not so critical and if the aerial vehicle is phase, such as a take-off phase or landing phase, the at least one stakeholder may prefer not to receive the alerts and recommendations. In some other scenarios, irrespective of the criticality of anomaly or the phase of the aerial vehicle, the at least one stakeholder may prefer to receive the alert and the recommendations. Therefore, at step 416, it may be determined if the generation of the alerts and the recommendations are required. In this regard, options regarding the alerts and the recommendations may be customizable by the at least one stakeholder, as will be explained with reference to FIG. 6.

If, at step 416, if it is determined that the alerts and the recommendations are required, the method 400 may move to step 418. On the other hand, if it is determined that the alerts and the recommendations are not required, the method 400 may proceed to step 420.

At step 418, an alert may be triggered to the at least one stakeholder and one or more recommendations may be generated to be provided to the at least one stakeholder. The alert may be indicative of the anomaly in the operation of the engine, the type of the anomaly, the cause of the anomaly, and the spatial origin of the anomaly. The one or more recommendations generated may be to address the anomaly. Implementation of the one or more recommendation is intended to restore the component to the optimal working condition of the component.

As an example, an alert, indicating the piston damage, physical damage caused from debris or operational stress, and one or more locations of the anomaly in the piston, may be triggered to be provided to the at least one stakeholder. Further, the one or more recommendations, including instructions to perform a thorough inspection and repair or replace the damaged components, may be provided to the at least one stakeholder.

Further, in some scenarios, in response to the provision of the alerts and the one or more recommendations, one or more feedback may be obtained from the at least one stakeholder. In such scenarios, the method 400 may include updating of the analysis model based on the feedback. In addition, in some scenarios, new operation data, such as new detection parameters, new reference detection parameters, new baseline anomaly signature, new set of predefined anomalies, or the like, may be received. In such scenarios, the analysis model may be updated based on new operational data.

At step 420, triggering alerts and generation of the one or more recommendations may be refrained from based on the determination that the alerts and the recommendations are not required to be generated.

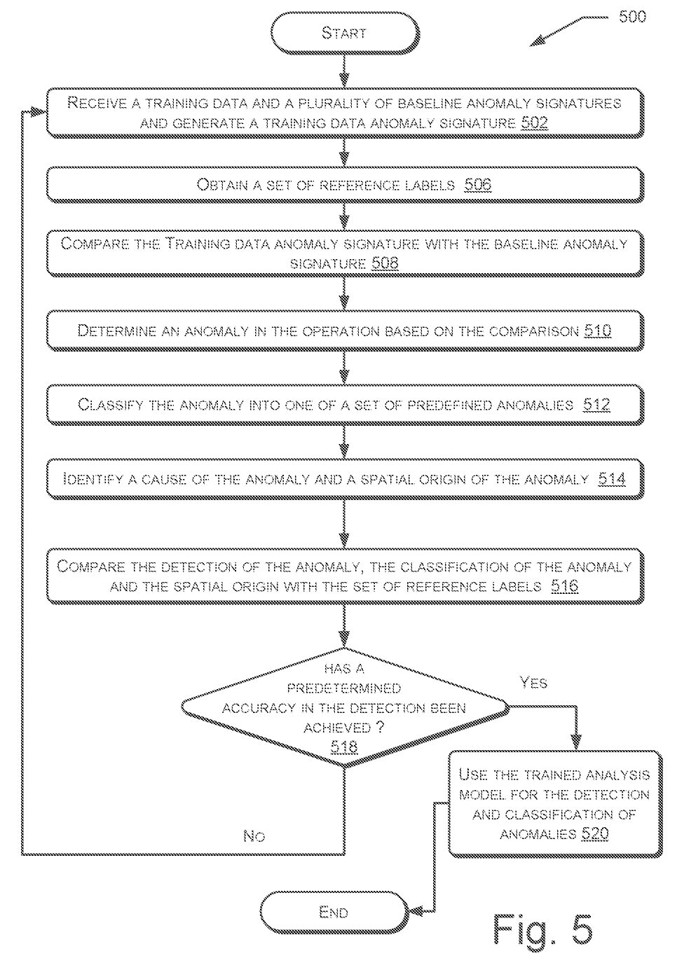

As will be understood, the analysis model referred to herein is a trained analysis model. The analysis model may be trained to preprocess the set of detection parameters, extract the set of detection features, to generate anomaly signature, determine the anomaly, the type of anomaly, the cause of the anomaly, and the spatial origin of the anomaly. In addition, the analysis model may be trained to trigger the alerts and provide the one or more recommendations. In addition, the analysis model may be trained to configure the detection parameters and to configure the alerts and the one or more recommendations. The configuring may be performed based on input from the at least one stakeholder. Further, the analysis model may be trained to generate the baseline anomaly signature based on baseline detection parameters. The training of the analysis model will be explained with reference to FIG. 5.

In the above example, the detection parameters, options regarding the alert and the one or more recommendations may be chosen automatically. However, in some examples, user inputs may be used to configure the detection parameters, the alerts, and the one or more recommendations, as will be explained with reference to FIG. 6.

FIG. 5 illustrates a method 500 for training of an analysis model for use in detection of anomalies in a component, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 100, the system 200, or the system 300. In particular, the method 500 may be performed by the processing unit 102, the processing unit 202, or the processing unit 302. Herein, the training of the analysis model is explained.

Referring to FIG. 5, at step 502, a training data may be received. The training data may include a set of detection parameters. The set of detection parameters may be, for example, set by a user or set automatically. In an example, the set of detection parameters may include acoustic parameters, vibration parameters, and spatial origin parameters. While in other examples, other detection parameters may be included.

Further, based on the training data, a training data anomaly signature may be generated. For generating the training data anomaly signature, the training data may be preprocessed using noise filtering and signal normalization techniques. Further, from the training data, a set of detection features may be extracted. Based on the set of detection features, the training data anomaly signature may be determined. In an example, the training data anomaly signature may include a plurality of temporal patterns and a plurality of spectral representations. In particular, the plurality of spectral representations may include a set of spectrograms and a set of frequency-domain features. The temporal patterns may include temporal dependencies corresponding to vibration of the component. In other examples, the training data anomaly signature may include other representations or patterns.

In addition, a plurality of baseline anomaly signatures may be received. The baseline anomaly signature may correspond to an optimal working condition of the component. The baseline anomaly signature may include a plurality of baseline temporal patterns and a plurality of baseline spectral representations. In particular, the plurality of baseline spectral representations may include a set of baseline spectrograms and a set of baseline frequency-domain features. The temporal patterns may include baseline temporal dependencies corresponding to vibration of the component. In other examples, the baseline anomaly signature may include other representations or patterns.

At step 506, a set of reference labels may be obtained. The set of reference labels may include data of presence of the anomaly, a type of the anomaly, a cause of the anomaly, and a spatial origin of the anomaly corresponding to the training data. In addition, in an example, the set of reference labels may include data corresponding to alerts and one or more recommendations. The alerts may indicate the presence of the anomaly, the type of the anomaly, the cause of the anomaly, a spatial origin of the anomaly, or a combination thereof. The one or more recommendations may address of the anomaly. The implementation of the one or more recommendations may be intended to the restore the optimal working condition of the component.

At step 508, the training data anomaly signature may be compared with the baseline anomaly signature. In other words, the plurality of temporal patterns of the training data may be compared with the plurality of baseline temporal patterns and the plurality of spectral representations of the training data may be compared with the plurality of baseline spectral representations.

At step 510, an anomaly in the operation of the component may be determined based on the comparison. For instance, if there is a deviation in the training data anomaly signature from the baseline anomaly signature, it may be determined that there is an anomaly. If there is no deviation of the training data anomaly signature from the baseline anomaly signature, it may be determined that there is no anomaly.

At step 512, in response to the determination of the anomaly, the anomaly may be classified into one of a set of predefined anomalies. The predefined anomalies may be provided to the analysis model for the classification. At step 514, a cause of the anomaly and the spatial origin of the anomaly may be detected. Further, at step 516, the detection of the anomaly, the classification of the anomaly, and the spatial origin of the anomaly may be compared with the set of reference labels for the training. In addition, in an example, the analysis model may also be trained using the set of reference labels for the triggering of the alert and the provision of the one or more recommendations.

At step 518, it may be determined if a predetermined accuracy in the detection has been achieved. For the determination, a plurality of test data may be used to validate. In other words, for the plurality of test data, it may be determined if the analysis model is able to rightly detect the presence of the anomaly (including the type, the cause, and the spatial origin of the anomaly) or the absence of the anomaly. In addition, it may be determined if the analysis model is able to rightly trigger the alerts and provide the one or more recommendations in response to the detection of the anomaly.

At step 518, if it is determined that the predetermined accuracy in the detection is not achieved, the training may be repeated for a new training data. In other words, the method may proceed to repeat the steps from 502. On the other hand, if it is determined that the predetermined accuracy in the detection has been achieved, the method 500 may proceed to step 520. At step 520, the trained analysis model may be usable for the detection of the anomalies. The trained analysis model may correspond to the analysis model 106 or the analysis model 206.

FIG. 6 illustrates a method 600 of configuring an analysis model in detection of anomalies in a component, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media.

In an example, the method 600 may be performed by the system 100, the system 200 or the system 300. In particular, the method 600 may be performed by the processing unit 102, the processing unit 202 or the processing unit 302. The analysis model may correspond to the analysis model 106 or the analysis model 206. The analysis model may be usable for the detection of an anomaly in the operation of one or more components of an aerial vehicle. The aerial vehicle may correspond to the aerial vehicle 110 or the aerial vehicle 210. The components may correspond to the components 112 or the plurality of components 212-1, 212-2,…,212-N. Hereinafter, the configuration of the analysis model will be explained with reference to a single component.

At step 602, it may be determined if a set of inputs may be received. The set of inputs may include inputs corresponding to selection of one or more detection parameters used for the detection of the anomalies in the component. The set of inputs may be provided by at least one stakeholder corresponding to the aerial vehicle, such as the at least one stakeholder 120 or the at least one stakeholder 220.

If, at step 602, it is determined that the set of inputs is received, the method 600 may proceed to step 604. On the other hand, if the set of inputs is received, the method 600 may proceed to step 604. At step 604, the one or more detection parameters may be set based on the inputs received. Further, at step 606, a plurality of reference detection parameters may be received. The plurality of reference detection parameters may correspond to the detection parameters in optimal working condition of the component. At step 608, based on the plurality of reference detection parameters, a plurality of baseline spectral signature may be generated. The baseline spectral signature may also be referred to as “the baseline anomaly signature” or “the baseline composite anomaly signature”.

At step 610, it may be determined if inputs corresponding to triggering alerts have been received. The triggering of the alerts may correspond to the step 418 of FIG. 4. The inputs may correspond to options for triggering the alerts. In some scenarios, the at least one stakeholder may select options, such as mode of triggering the alert, timing of triggering the alert, time duration of the alert, and the like. For instance, the mode may include audio alert and/or video alerts. The timing of triggering the alert may be set based on the phase of operation of the aerial vehicle. For instance, the at least one stakeholder may choose to avoid triggering of the alerts when the aerial vehicle is in certain phases, such as closer to take off, closer to landing, take off, landing, and the like. The time duration of the alert may include duration for which the alert has to be triggered to the at least one stakeholder.

If, at step 610, it is determined that the inputs corresponding to the triggering of the alerts have been received, the method 600 may proceed to step 612. On the other hand, if it is determined that the inputs have not been received, the method 600 may proceed to step 614.

At step 612, it may be determined if inputs corresponding to providing one or more recommendations have been received. The provision of the one or more recommendations may correspond to the step 418 of FIG. 4. The inputs may correspond to options for providing the one or more recommendations. In an example, options may include, such as the mode of providing the recommendations, type of recommendations to be provided to each stakeholder 120 (in case of multiple stakeholders 120), timing of providing the recommendations, and the like. The mode of providing the recommendations may include various styles of providing the recommendations, such as in the form of graphical representation, text, audio, and the like. In addition, the mode of providing the recommendations may also include suggesting style of presentation of a GUI, such as the one including a chat box, through which the recommendations are provided to the at least one stakeholder. The type of recommendations may include a certain type of recommendations to be provided to pilots, a certain type of recommendations to be provided to only maintenance personnel, and the like. The timing of providing the recommendation may be set based on the phase of operation of the aerial vehicle. For instance, the at least one stakeholder may choose to avoid receiving the recommendations when the aerial vehicle is in certain phases, such as closer to take off, closer to landing, take off, landing, and the like.

If, at step 612, it is determined that the inputs corresponding to providing the recommendations have been received, the method 600 may proceed to step 616. On the other hand, if it is determined that the inputs corresponding to providing the recommendations have not been received, the method 600 may proceed to step 614.

At step 614, inputs corresponding to default options for the triggering the alerts and the provision of the one or more recommendations may be received from the at least one stakeholder. In this regard, the default options for the triggering the alerts and the provision of the one or more recommendations may be provided to the at least one stakeholder. The at least one stakeholder may either select the default options or edit the default options to customize the triggering of the alerts and the provision of the one or more recommendations. Subsequently, at step 618, the analysis model may be configured based on the inputs. The analysis model may be used in the detection of the anomaly, as explained with reference to FIG. 4. In response to receiving the inputs for the recommendations (step 612), the analysis model may be configured based on the inputs of the alerts and the recommendations received from the at least one stakeholder, at step 616.

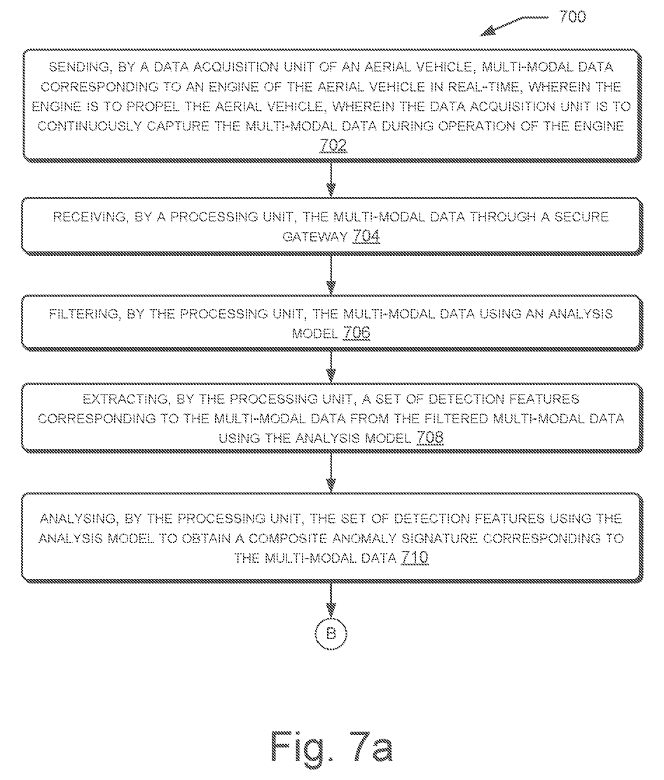

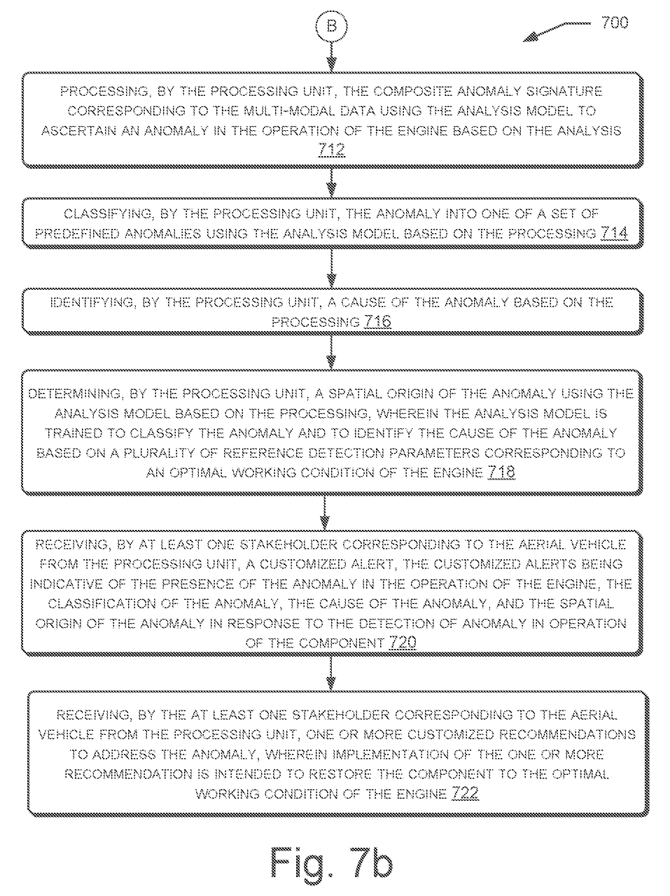

FIGS. 7a-7b illustrate a method 700 for detection of anomalies in a component, according to an example implementation of the present subject matter. The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof.

It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media.

In an example, the method 700 may be performed by the system 100, the system 200, or the system 300. In particular, the method 700 may be performed by the processing unit, such as the processing unit 102, the processing unit 202, or the processing unit 302. The method 700 may be performed by using the analysis model. The analysis model may correspond to the analysis model 106 or the analysis model 206. The component may correspond to a component of an aerial vehicle. The aerial vehicle may correspond to the aerial vehicle 110 or the aerial vehicle 210. The component may correspond to the component 112 or a component of the plurality of components 212-1, 212-2,…212-N. Hereinafter, the component will be explained with reference to an engine of the aerial vehicle. The engine may propel the aerial vehicle. While in the below example, the detection of anomaly will be explained with reference to the engine, the detection of anomaly can be performed simultaneously for other components of the aerial vehicle in addition to or instead of the engine.

Referring to FIG. 7a, at step 702, multi-modal data corresponding to the engine of the aerial vehicle may be sent in real-time by a data acquisition unit of the aerial vehicle. The data acquisition unit may continuously capture the multi-modal data during operation of the engine. The multi-modal data may correspond to the set of detection parameters, as explained at least with reference to FIGS. 4a and FIG. 4b. The data acquisition unit may correspond to the data acquisition unit 216.

At step 704, the multi-modal data may be received by the processing unit through a secure gateway. The secure gateway may correspond to the secure gateway 218. At step 706, the multi-modal data may be filtered by the processing unit using the analysis model. At step 708, a set of detection features corresponding to the multi-modal data may be extracted from the filtered multi-modal data using the analysis model. The extraction may be done by the processing unit. In an example, the set of detection features may include frequency components, variation of amplitude, temporal patterns of sound, and temporal patterns of vibration, or a combination thereof.

At step 710, the set of detection features may be analysed, by the processing unit, using the analysis model to obtain a composite anomaly signature corresponding to the multi-modal data. The composite anomaly signature may correspond to the anomaly signature as explained at least with reference to FIGS. 4a and 4b.

Referring to FIG. 7b, at step 712, the method 700 may include processing, by the processing unit, the composite anomaly signature corresponding to the multi-modal data using the analysis model to ascertain an anomaly in the operation of the engine based on the analysis. At step 714, the anomaly may be classified by the processing unit into one of a set of predefined anomalies using the analysis model based on the processing. At step 716, the method 700 may include identifying, by the processing unit, a cause of the anomaly based on the processing.

At step 718, a spatial origin of the anomaly may be determined, by the processing unit, using the analysis model based on the processing. The analysis model may be trained to classify the anomaly and to identify the cause of the anomaly based on a plurality of reference detection parameters corresponding to an optimal working condition of the engine. At step 720, a customized alert may be received by at least one stakeholder corresponding to the aerial vehicle. The at least one stakeholder may correspond to the at least one stakeholder 120 or the at least one stakeholder 220. The customized alerts may be indicative of the presence of the anomaly in the operation of the engine, the classification of the anomaly, the cause of the anomaly, and the spatial origin of the anomaly in response to the detection of anomaly in operation of the component.

At step 722, the method 700 may include receiving, by the at least one stakeholder corresponding to the aerial vehicle from the processing unit, one or more customized recommendations to address the anomaly. Implementation of the one or more recommendation is intended to restore the component to the optimal working condition of the engine.

The method 700 may include the sending of the multi-modal data from the data acquisition unit may include the following steps. sending, from a first set of sensors of the data acquisition unit, a set of acoustic parameters, sending, from a second set of sensors of the data acquisition unit, a set of vibration parameters, and sending, from a third set of sensors of the data acquisition unit, spatial origin of acoustic waves in the engine.

The first set of sensors may be integrated at a first plurality of locations of the aerial vehicle relative to the engine. The first set of sensors may include a set of microphones. The second set of sensors may be integrated at a second plurality of locations of the aerial vehicle relative to the engine. The second set of sensors may include a set of accelerometers. The third set of sensors may be integrated at a third plurality of locations of the aerial vehicle relative to the engine. The third set of sensors may include a set of position sensors.

The method 700 may include training, by the processing unit, the analysis model with a plurality of reference detection parameters prior to the obtaining of the multi-modal data. The training may include the following steps:

A baseline composite anomaly signature may be generated, by the processing unit, based on the plurality of reference detection parameters. A training multi-modal data may be obtained by the processing unit. A training composite anomaly signature may be generated, by the processing unit, based on the training multi-modal data. The training composite anomaly signature may be compared, by the processing unit, with the baseline composite anomaly signature. An anomaly in the operation of the engine may be ascertained, by the processing unit, based on the comparison. The anomaly may be classified, by the processing unit, into one of a set of predefined anomalies using the analysis model based on the ascertaining. A cause of the anomaly may be identified, by the processing unit, using the analysis model based on the ascertaining. The training may include determining, by the processing unit, a spatial origin of the anomaly using the analysis model based on the ascertaining using the analysis model. Further, the training may include comparing, by the processing unit, the classification of the anomaly, and the identified cause of the anomaly with a set of reference labels. The set of reference labels may include classification of the anomaly and cause of the anomaly corresponding to the training multi-modal data. The training may be repeated for a plurality of training multi-modal data to achieve a predetermined accuracy for the classification of the anomaly and for the identification of the cause of the anomaly.

In an example, the composite anomaly signature may include a plurality of spectral representations corresponding to the multi-modal data. The processing of the composite anomaly signature using the analysis model may include analyzing, by the processing unit, the plurality of spectral representations using a CNN. In another example, the composite anomaly signature may include a plurality of temporal patterns derived from the multi-modal data. In such an example, the processing of the composite anomaly signature using the analysis model may include analyzing, by the processing unit, the plurality of temporal patterns using an RNN. In yet another example, the composite anomaly signature may include a plurality of spectral representations corresponding to the multi-modal data and a plurality of temporal patterns derived from the multi-modal data. The processing of the composite anomaly signature using the analysis model may include analyzing, by the processing unit, the plurality of spectral representations using a CNN to produce a spatial anomaly signature and the plurality of temporal patterns using an RNN to produce a temporal anomaly signature. Further, the spatial anomaly signature and the temporal anomaly signature may be fused by the processing unit.

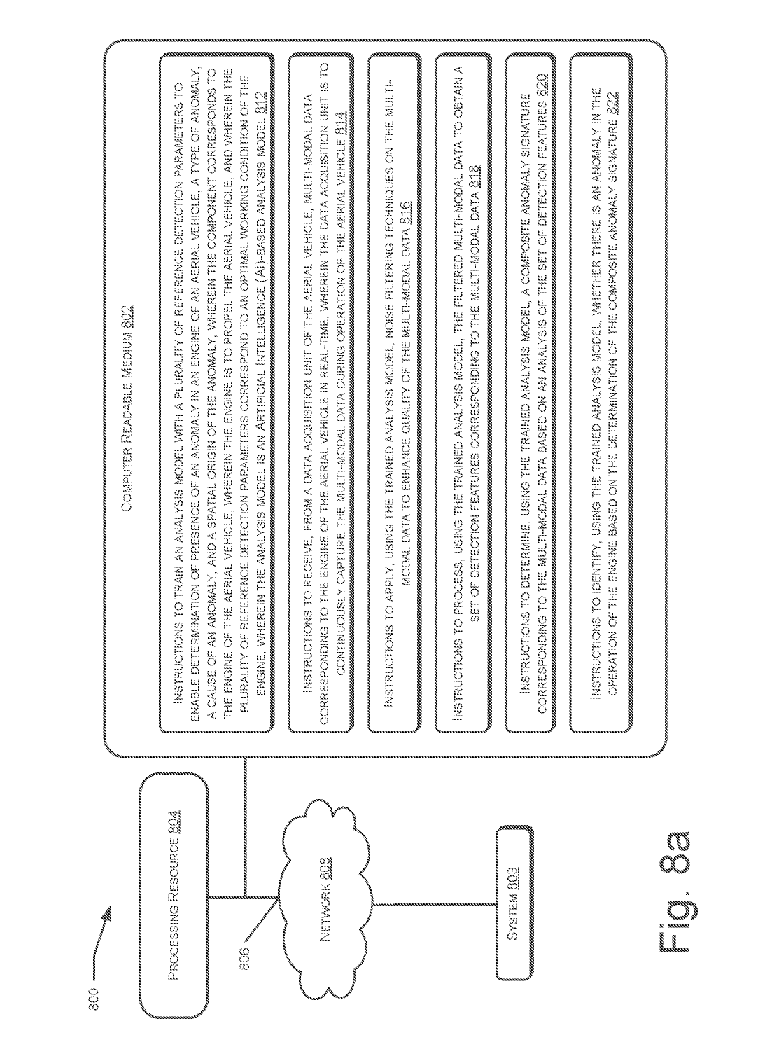

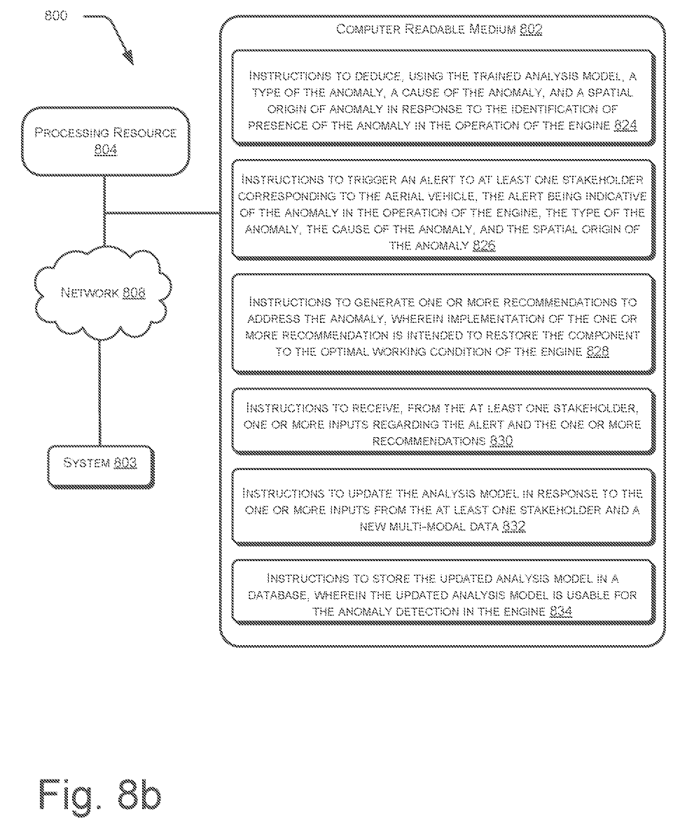

FIGS. 8a-8b illustrate a computing environment 800, implementing a non-transitory computer-readable medium 802 for detection of anomalies in a component, according to an example implementation of the present subject matter.

In an example, the non-transitory computer-readable medium 802 may be utilized by the system 803. The system 803 may correspond to the system 100, the system 200, or the system 300. The system 803 may be implemented in a public networking environment or a private networking environment. In an example, the computing environment 800 may include a processing resource 804 communicatively coupled to the non-transitory computer-readable medium 802 through a communication link 806.

In an example, the processing resource 804 may be implemented in a device, such as the system 803. The processing resource 804 may correspond to the processing unit 102, the processing unit 202, or the processing unit 302. The non-transitory computer-readable medium 802 may be, for example, an internal memory device of the system 803 or an external memory device. The non-transitory computer-readable medium 802 may correspond to the memory 104 or the memory 204. In an implementation, the communication link 806 may be a direct communication link, such as any memory read/write interface. In another implementation, the communication link 806 may be an indirect communication link, such as a network interface. In such a case, the processing resource 804 may access the non-transitory computer-readable medium 802 through a network 808. The network 808 may be a single network or a combination of multiple networks and may use a variety of different communication protocols. The processing resource 804 and the non-transitory computer-readable medium 802 may also be communicatively coupled to the system 803 over the network 808.

In an example implementation, the non-transitory computer-readable medium 802 includes a set of computer-readable instructions for detection of anomalies in a component. The set of computer-readable instructions can be accessed by the processing resource 804 through the communication link 806 and subsequently executed to perform acts for detection of anomalies in a component.

The detection of the anomalies may be performed by using the analysis model. The analysis model may correspond to the analysis model 106 or the analysis model 206. The component may correspond to a component of an aerial vehicle. The aerial vehicle may correspond to the aerial vehicle 110 or the aerial vehicle 210. The component may correspond to the component 112 or a component of the plurality of components 212-1, 212-2,…212-N. Hereinafter, the component will be explained with reference to an engine of the aerial vehicle. The engine may propel the aerial vehicle. While in the below example, the detection of anomaly will be explained with reference to the engine, the detection of anomaly can be performed simultaneously for other components of the aerial vehicle in addition to or instead of the engine.

Referring to FIG. 8a, in an example, the non-transitory computer-readable medium 802 includes instructions 812 to train an analysis model with a plurality of reference detection parameters to enable determination of presence of an anomaly in an engine of an aerial vehicle, a type of anomaly, a cause of an anomaly, and a spatial origin of the anomaly. The plurality of reference detection parameters may correspond to an optimal working condition of the engine. The analysis model may be, for example, an Artificial Intelligence (AI)-based analysis model.

The non-transitory computer-readable medium 802 includes instructions 814 to receive, from a data acquisition unit of the aerial vehicle, multi-modal data corresponding to the engine of the aerial vehicle in real-time. The data acquisition unit may continuously capture the multi-modal data during operation of the aerial vehicle. The data acquisition unit may correspond to the data acquisition unit 216.

The non-transitory computer-readable medium 802 includes instructions 816 to apply, using the trained analysis model, noise filtering techniques on the multi-modal data to enhance quality of the multi-modal data. The non-transitory computer-readable medium 802 includes instructions 818 to process, using the trained analysis model, the filtered multi-modal data to obtain a set of detection features corresponding to the multi-modal data.

The non-transitory computer-readable medium 802 includes instructions 820 to determine, using the trained analysis model, a composite anomaly signature corresponding to the multi-modal data based on an analysis of the set of detection features. The non-transitory computer-readable medium 802 includes instructions 822 to identify, using the trained analysis model, whether there is an anomaly in the operation of the engine based on the determination of the composite anomaly signature.

Referring to FIG. 8b, the non-transitory computer-readable medium 802 includes instructions 824 to deduce, using the trained analysis model, a type of the anomaly, a cause of the anomaly, and a spatial origin of anomaly in response to the identification of presence of the anomaly in the operation of the engine.

The non-transitory computer-readable medium 802 includes instructions 826 to trigger an alert to at least one stakeholder corresponding to the aerial vehicle. The alert may be indicative of the anomaly in the operation of the engine, the type of the anomaly, the cause of the anomaly, and the spatial origin of the anomaly. The non-transitory computer-readable medium 802 includes instructions 828 to generate one or more recommendations to address the anomaly. Implementation of the one or more recommendation may be intended to restore the component to the optimal working condition of the engine. The non-transitory computer-readable medium 802 includes instructions 830 to receive, from the at least one stakeholder, one or more inputs regarding the alert and the one or more recommendations. The non-transitory computer-readable medium 802 includes instructions 832 to update the analysis model in response to the one or more inputs from the at least one stakeholder and a new multi-modal data.

The non-transitory computer-readable medium 802 includes instructions 834 to store the updated analysis model in a database. The updated analysis model may be usable for the anomaly detection in the engine.

In an example, the non-transitory computer-readable medium 802 may include instructions to refrain from triggering the alert in response to the identification of absence of the anomaly in the operation of the engine. In an example, the anomaly may include at least one of abnormal vibrations of a piston of the engine, knocking sound associated with the piston, clanking sound associated with the piston, high-frequency knocking sound of the engine, high-frequency pinging sound of the engine, high-frequency vibration corresponding to knocking of the engine, hissing noise of the engine, hissing vibration of the engine, squealing noise of the engine, irregular ratting noise of the engine, high-pitched whining noise of the engine, and excessive heat of the engine. The cause of anomaly may include at least one of wear of a piston of the engine, damage of the piston of the engine, pre-ignition, detonation, air leaks in the engine, engine cooling system issue, faulty belt operation in the engine, faulty pulley operation in the engine, problems corresponding to bearings of the engine, loose components in the engine, worn components of the engine, turbocharger issues, gearbox issues, cooling system failures, and overheating of parts of the engine.

While in all the above examples, non-limiting anomalies, the types of anomalies, the cause of the anomalies, the spatial origin of the anomalies, the recommendations to address the anomalies have been mentioned, the present subject matter can detect other anomalies, other type of anomalies, other cause of anomalies, other spatial origin of the anomalies, and provide other recommendations to address the anomalies than ones specifically listed.

The present subject matter aims to enhance the reliability and performance of components, such as engine of aircrafts, through continuous monitoring, real-time analysis, and proactive maintenance. The present subject matter enables prognostic detection of anomalies and thereby, increasing the life span of the components. By combining multi-modal data analysis, advanced machine learning techniques, and stakeholder engagement, the present subject matter provides a robust solution for detecting and addressing anomalies in critical components of aerial vehicles. With the present subject matter, the accuracy of fault detection and classification is enhanced. For instance, by using adaptive learning of AI-based models to analyze spatial and temporal patterns in the sensor data, the present subject matter offers high accuracy in identifying and categorizing engine faults, reducing misdiagnoses, and unnecessary maintenance. Since the present subject matter continually learns and updates the analysis model, the present subject matter enables identification of new fault patterns. By using angle-of-noise data, the present subject matter identifies the exact location of the fault within the engine. Therefore, the present subject matter eliminates the cumbersome and complex process of identification of the location of the fault manually by the maintenance personnel. Therefore, the present subject matter streamlines maintenance and repair processes.

With the present subject matter, sensors are used to identify data about health and performance of the engine. Therefore, with the present subject matter, the process of disassembly to assess engine health and performance is eliminated. Accordingly, the present subject matter reduces downtime and maintenance costs. The present subject matter can forecast potential faults and failure and thereby allowing proactive maintenance and reducing unscheduled downtimes. The present subject matter provides customized alerts and recommendations to various stakeholders involved in aircraft maintenance and operation. By detecting faults early, the present subject matter enhances safety and reduces the risk of in-flight engine failures, and the related damages caused to the passengers.

With the present subject matter, security of data is ensured. The present subject matter allows user, such as airlines, maintenance personnel, manufacturers of components, and the like, to configure the detection parameters and enable identification of the anomaly in-house. In other words, the users may not have to share the data of the aircraft to perform the detection or to update the analysis model regularly. In addition, the transmission of the sensor data from the aircraft is also performed through a secure gateway. Therefore, the present subject matter ensures enhanced security of data, which is critical in the field of aviation.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for detection of anomalies in a component, the system comprising:
a processing unit to:
obtain, from a plurality of sensors corresponding to the component, one or more detection parameters, wherein the plurality of sensors are configured to continuously capture the one or more detection parameters during operation of the component, wherein the component is a part of an aerial vehicle;
process the one or more detection parameters, wherein the processing comprises extraction of a set of detection features corresponding to the one or more detection parameters;
ascertain, using an analysis model, a plurality of spectral representations corresponding to the extracted set of detection features;
determine, using the analysis model, an anomaly in operation of the component based on the plurality of spectral representations;
identify, using the analysis model, a type of anomaly in the operation of the component and a cause of the anomaly in the operation of the component, wherein the analysis model is trained to determine the anomaly and to identify the type of anomaly in the operation of the component and the cause of the anomaly in the operation of the component based on a plurality of baseline spectral representations, wherein the plurality of baseline spectral representations correspond to an optimal working condition of the component;
trigger an alert in response to the determination of anomaly in the operation of the component; and
provide one or more recommendations to address the anomaly, wherein implementation of the one or more recommendations is intended to restore the component to the optimal working condition of the component.

2. The system of claim 1, wherein the one or more detection parameters comprise at least one of: a set of acoustic parameters, a set of vibration parameters, and a set of spatial origin parameters.

3. The system of claim 1, wherein the component is a moving part of the aerial vehicle.

4. The system of claim 1, wherein the processing unit is to determine, using the analysis model, a location of the anomaly within the component.

5. The system of claim 1, wherein the processing unit is to:
preprocess the one or more detection parameters prior to the processing of the obtained one or more detection parameters from the plurality of sensors, wherein to preprocess, the processing unit is to:
apply, using the analysis model, a plurality of noise reduction techniques and signal normalization techniques.

6. The system of claim 1, wherein the plurality of spectral representations comprises at least one of: a set of spectrograms, a set of frequency-domain features, and temporal dependencies corresponding to vibration of the component.

7. The system of claim 1, wherein the analysis model is an Artificial Intelligence(AI)-based model.

8. The system of claim 1, wherein the processing unit is to:
receive, from a user, a set of inputs to configure the one or more detection parameters;
set the one or more detection parameters based on the inputs received from the user;
obtain, using the analysis model, a plurality of reference detection parameters, wherein the plurality of reference detection parameters corresponds to the one or more detection parameters in the optimal working condition of the component;
generate, using the analysis model, the plurality of baseline spectral representations; and
obtain, from the plurality of sensors, the one or more detection parameters captured during operation of the component upon the generation of the plurality of baseline spectra.

9. The system of claim 1, wherein the processing unit is to:
obtain, from a set of users corresponding to the aerial vehicle, feedback regarding the alert and the one or more recommendations; and
update the analysis model based on the feedback and a new operational data corresponding to the one or more detection parameters.

10. A method for detection of anomalies in a component, the method comprising:
sending, by a data acquisition unit of an aerial vehicle, multi-modal data corresponding to an engine of the aerial vehicle in real-time, wherein the engine is to propel the aerial vehicle, wherein the data acquisition unit is to continuously capture the multi-modal data during operation of the engine;
receiving, by a processing unit, the multi-modal data through a secure gateway;
filtering, by the processing unit, the multi-modal data using an analysis model;
extracting, by the processing unit, a set of detection features corresponding to the multi-modal data from the filtered multi-modal data using the analysis model;
analysing, by the processing unit, the set of detection features using the analysis model to obtain a composite anomaly signature corresponding to the multi-modal data;
processing, by the processing unit, the composite anomaly signature corresponding to the multi-modal data using the analysis model to ascertain an anomaly in operation of the engine based on the analysis;
classifying, by the processing unit, the anomaly into one of a set of predefined anomalies using the analysis model based on the processing;
identifying, by the processing unit, a cause of the anomaly based on the processing;
determining, by the processing unit, a spatial origin of the anomaly using the analysis model based on the processing, wherein the analysis model is trained to ascertain the anomaly, to classify the anomaly, and to identify the cause of the anomaly based on a plurality of reference detection parameters corresponding to an optimal working condition of the engine;
receiving, by at least one stakeholder corresponding to the aerial vehicle from the processing unit, a customized alert, the customized alert being indicative of the presence of the anomaly in the operation of the engine, the classification of the anomaly, the cause of the anomaly, and the spatial origin of the anomaly in response to the ascertaining of the anomaly in the operation of the engine; and
receiving, by the at least one stakeholder corresponding to the aerial vehicle from the processing unit, one or more customized recommendations to address the anomaly, wherein implementation of the one or more recommendations is intended to restore the engine to the optimal working condition of the engine.

11. The method of claim 10, wherein the sending of the multi-modal data from the data acquisition unit comprises:
sending, from a first set of sensors of the data acquisition unit, a set of acoustic parameters, wherein the first set of sensors are integrated at a first plurality of locations of the aerial vehicle relative to the engine, and wherein the first set of sensors comprises a set of microphones;
sending, from a second set of sensors of the data acquisition unit, a set of vibration parameters, wherein the second set of sensors are integrated at a second plurality of locations of the aerial vehicle relative to the engine, and wherein the second set of sensors comprises a set of accelerometers; and
sending, from a third set of sensors of the data acquisition unit, spatial origin of acoustic waves in the engine, wherein the third set of sensors are integrated at a third plurality of locations of the aerial vehicle relative to the engine, and wherein the third set of sensors comprises a set of position sensors.

12. The method of claim 10, wherein the set of detection features comprises frequency components, variation of amplitude, temporal patterns of sound, and temporal patterns of vibration, or a combination thereof.

13. The method of claim 10, comprising:
training, by the processing unit, the analysis model with a plurality of reference detection parameters prior to the receiving of the multi-modal data, wherein the training comprises:
generating, by the processing unit, a baseline composite anomaly signature based on the plurality of reference detection parameters; and
obtaining, by the processing unit, a training multi-modal data;
generating, by the processing unit, a training composite anomaly signature based on the training multi-modal data;
comparing, by the processing unit, the training composite anomaly signature with the baseline composite anomaly signature;
ascertaining, by the processing unit, an anomaly in the operation of the engine based on the comparison;
classifying, by the processing unit, the anomaly into one of a set of predefined anomalies using the analysis model based on the ascertaining;
identifying, by the processing unit, a cause of the anomaly based on the ascertaining using the analysis model;
determining, by the processing unit, a spatial origin of the anomaly using the analysis model based on the ascertaining using the analysis model; and
comparing, by the processing unit, the classification of the anomaly, and the identified cause of the anomaly with a set of reference labels, wherein the set of reference labels comprises classification of the anomaly and cause of the anomaly corresponding to the training multi-modal data, wherein the training is repeated for a plurality of training multi-modal data to achieve a predetermined accuracy for the classification of the anomaly and for the identification of the cause of the anomaly.

14. The method of claim 10, wherein the composite anomaly signature comprises a plurality of spectral representations corresponding to the multi-modal data, wherein the processing of the composite anomaly signature using the analysis model comprises:
analyzing, by the processing unit, the plurality of spectral representations using a Convolutional Neural Network (CNN).

15. The method of claim 10, wherein the composite anomaly signature comprises a plurality of temporal patterns derived from the multi-modal data, wherein the processing of the composite anomaly signature using the analysis model comprises:
analyzing, by the processing unit, the plurality of temporal patterns using a Recurrent Neural Network (RNN).

16. The method of claim 10, wherein the composite anomaly signature comprises a plurality of spectral representations corresponding to the multi-modal data and a plurality of temporal patterns derived from the multi-modal data, wherein the processing of the composite anomaly signature using the analysis model comprises:
analyzing, by the processing unit, the plurality of spectral representations using a CNN to produce a spatial anomaly signature and the plurality of temporal patterns using a RNN to produce a temporal anomaly signature; and
fusing, by the processing unit, the spatial anomaly signature and the temporal anomaly signature.

17. A non-transitory computer-readable medium comprising instructions for detection of anomalies in a component, the instructions being executable by a processing resource to:
train an analysis model with a plurality of reference detection parameters to enable determination of presence of an anomaly in an engine of an aerial vehicle, a type of anomaly, a cause of an anomaly, and a spatial origin of the anomaly, wherein the component corresponds to the engine of the aerial vehicle, wherein the engine is to propel the aerial vehicle, and wherein the plurality of reference detection parameters correspond to an optimal working condition of the engine, wherein the analysis model is an Artificial Intelligence (AI)-based analysis model;
receive, from a data acquisition unit of the aerial vehicle, multi-modal data corresponding to the engine of the aerial vehicle in real-time, wherein the data acquisition unit is to continuously capture the multi-modal data during operation of the aerial vehicle;
apply, using the trained analysis model, noise filtering techniques on the multi-modal data to enhance quality of the multi-modal data;
process, using the trained analysis model, the filtered multi-modal data to obtain a set of detection features corresponding to the multi-modal data;
determine, using the trained analysis model, a composite anomaly signature corresponding to the multi-modal data based on an analysis of the set of detection features;
identify, using the trained analysis model, whether there is an anomaly in the operation of the engine based on the determination of the composite anomaly signature;
deduce, using the trained analysis model, a type of the anomaly, a cause of the anomaly, and a spatial origin of the anomaly in response to the identification of presence of the anomaly in the operation of the engine;
trigger an alert to at least one stakeholder corresponding to the aerial vehicle, the alert being indicative of the anomaly in the operation of the engine, the type of the anomaly, the cause of the anomaly, and the spatial origin of the anomaly;
generate one or more recommendations to address the anomaly, wherein implementation of the one or more recommendations is intended to restore the component to the optimal working condition of the engine;
receive, from the at least one stakeholder, one or more inputs regarding the alert and the one or more recommendations;
update the analysis model in response to the one or more inputs from the at least one stakeholder and a new multi-modal data; and
store the updated analysis model in a database, wherein the updated analysis model is usable for the anomaly detection in the engine.

18. The non-transitory computer-readable medium of claim 17, the instructions being executable by the processing resource to:
refrain from triggering the alert in response to the identification of absence of the anomaly in the operation of the engine.

19. The non-transitory computer-readable medium of claim 17, wherein the anomaly comprises at least one of: abnormal vibrations of a piston of the engine, knocking sound associated with the piston, clanking sound associated with the piston, high-frequency knocking sound of the engine, high-frequency pinging sound of the engine, high-frequency vibration corresponding to knocking of the engine, hissing noise of the engine, hissing vibration of the engine, squealing noise of the engine, irregular ratting noise of the engine, high-pitched whining noise of the engine, and excessive heat of the engine.

20. The non-transitory computer-readable medium of claim 17, wherein the type of anomaly comprises at least one of: wear of a piston of the engine, damage of the piston of the engine, pre-ignition, detonation, air leaks in the engine, engine cooling system issue, faulty belt operation in the engine, faulty pulley operation in the engine, problems corresponding to bearings of the engine, loose components in the engine, worn components of the engine, turbocharger issues, gearbox issues, cooling system failures, and overheating of parts of the engine.
